(19) United States
(12) Patent Application Publication
(10) Pub. No.: US 2013/0144654 A1
(43) Pub. Date: Jun. 6, 2013

(54) HEALTHCARE CO-MANAGEMENT PLATFORM

(71) Applicant: Michael Todd Andrews, San Clemente, CA (US)

(72) Inventor: Michael Todd Andrews, San Clemente, CA (US)

(73) Assignee: Waterman Technologies, San Clemente, CA (US)

(21) Appl. No.: 13/756,402

(22) Filed: Jan. 31, 2013

Related U.S. Application Data
(63) Continuation of application No. 12/939,868, filed on Nov. 4, 2010, now abandoned.
(60) Provisional application No. 61/258,142, filed on Nov. 4, 2009.

(51) Int. Cl. G06F 19/00

(52) U.S. Cl. CPC G06F 19/322
USPC 705/3

(57) ABSTRACT

A system, a method, and an electronic platform provide co-management for two or more business entities. In one aspect, the disclosure provides for a method including retrieving an electronic record for a client and storing first electronic record information for the client corresponding to a diagnosis of the client by the first business entity. The client is referred to the second business entity in response to the recommended service of the client, corresponding to service provided by the second business entity. The electronic record is provided to the second business entity, and second electronic record is stored for the client corresponding to service of the client by the second healthcare business entity. At least one follow-up visit is scheduled for the client at one of the first business entity or the second business entity. A first portion of a referral fee from the second business entity is distributed to the first business entity, and a second portion of the referral fee is distributed to a co-management system provider.

### CROSS-REFERENCE TO RELATED APPLICATIONS

This application claims priority to and the benefit of provisional patent application No. 61/258,142 and non-provisional patent application Ser. No. 12/939,868, filed in the United States Patent and Trademark Office on Nov. 4, 2009 and Nov. 4, 2010 respectively, the entire content of which is incorporated herein by reference.

### BACKGROUND

1. Field

The present disclosure relates generally to eyecare co-management systems, and more specifically, to systems, methods, and electronic platforms for co-management between two or more eyecare practices.

2. Background

In some portions of the instant disclosure, specific reference is made to eyecare co-management, specifically between optometrists and ophthalmologists, in order to illustrate background information and to provide specific examples. Those skilled in the art will comprehend that the scope of the instant disclosure is not limited to eyecare co-management, and that the various systems and methods disclosed herein may be implemented in various different healthcare fields.

The eye care market generally includes 2 types of clinicians: ophthalmologists and optometrists. An ophthalmologist is the surgeon and diagnostician for more serious eye disease. An optometrist or O.D. is also a doctor, and primarily takes eye measurements, fits for glasses, and performs non-surgical vision correction.

These two entities coexist in the eye care market and sometimes have casual business relationships in which they try and refer or share patients. Ophthalmology offices can be found in which both types of practitioners work under the same roof. Ophthalmologists generally make most of their money on surgery and optometrists generally make most of their money on seeing patients, performing visual field measurements and fitting them for glasses, and selling the glasses in their practice.

Recently there has been a push within the ophthalmology community to perform higher end, more expensive, advanced technology procedures. The medical insurance reimbursement for ophthalmologists is shrinking steadily, and surgeons are faced with declining margins for current or older technology surgeries or much higher margins for advanced technology procedures.

Current choices for an ophthalmologist are somewhat limited, as illustrated in the following two scenarios.

Scenario #1—Older surgical procedures take few man-hours for the surgeon and his staff to counsel or sell a patient on, even including pre- and post-operative care. These low technology surgical procedures are quick, generally taking only 10-15 minutes per eye. However, the profit margins are generally very low and the surgeon must perform a large quantity of these types of surgeries to turn a profit.

Scenario #2—Newer, advanced surgical procedures using cutting edge materials and state of the art technology take additional time for the surgeon and his staff to learn, and also take extra time to follow the patient before and after surgery. The profit margins are generally markedly higher than those for older, low-technology procedures (e.g., $3000.00 per eye vs. $600.00 per eye). Aside from profit, the surgeon is also improving his clinical reputation and is known as a leader in his field by utilizing state-of the art technology.

The obstacles to surgeons choosing scenario #2 include: the fear of new technology, the number of new technology choices increasing, clinical conservatism, not wanting to convert their existing business model, not having enough time to learn something new and teach it to their entire staff, and the conversion percentages of patients choosing a high technology expensive procedure are lower than the traditional technologies.

Nearly every person in their 50s or older will eventually develop cataracts, and will thus have a choice of a surgical lens to replace their surgically removed lens. An analogous situation, for ease of description, is that nearly everyone will have a TV that goes bad twice (one for each eye) and the consumer or patient will have to go to an electronics store and will be given a choice between watching a standard TV for $700.00 for the next 30 years, or watching a high definition, plasma model for $3,000.00. This is a simplified example, but very close to the business problem that has gained relevance within ophthalmology the last few years and is gaining steam.

In existing co-management schemes, ophthalmologists may identify and perfect a new technology, and then go to prominent optometrists in their area and invite them to dinner or lunch. The ophthalmologist presents the technology, educates the optometrist, reassures them of the safety and clinical results they are achieving, and finally, at the end of the meeting, tells the optometrist how much they will receive (e.g., $500.00/eye) if a patient is referred from the optometrist to the ophthalmologist, and the high technology surgical procedure is scheduled and performed. This commercial mating ritual is inherently flawed. For example:

It has to be reduplicated for each new technology, and the number of new advanced technologies is rapidly expanding;

The optometrist doesn't truly master the new technology;

The optometrist possibly loses the patient to the ophthalmologist after referring the patient out, and thereby loses the associated fees that arise from those lost patient visits;

The optometrist also loses sales of glasses (their lifeblood) as the patient can also choose glasses at the ophthalmologist's office;

It is difficult to track payments between the two entities; and

The two entities keep separate collections of clinical data among for these patients, and lack knowledge of the other practitioner's data and control over patients seeing the other practitioner.

The flow of surgical patients is important to the process of utilizing high technology procedures for the ophthalmologist. There are vastly more optometrists than ophthalmologists, and the overwhelming majority of patients who eventually receive surgical procedures on their eyes begin by visiting an optometrist.

In one example, a potential eye care patient knows there is something off with their vision. Most of the time, this patient will visit the optometrist first, assuming that they need eyeglasses to fix the problem. The optometrist thus makes a diagnosis. The OD may make a diagnosis, for example, that the patient needs glasses, or sometimes, the patient needs a surgical procedure like a cataract procedure, lens-based procedure, lasik, etc. From there, the patient goes to the ophthalmologist. Thus, the optometrist sees the overwhelming majority of cataract and advanced surgical technology candidates first, and the patient's first education about their respective disease state and technology choices is through the optometrist.

Despite this favorable patient flow for optometrists, the optometrists have largely been left out of the market opportunities of sharing in high technology and/or expensive procedures with the ophthalmologists for all the reasons listed above. By the same token, the ophthalmologists have largely been unable to reach the top optometrists and have them effectively educate, manage, and send them high technology procedure referrals. The two clinical tribes are still using the flawed model in their futile attempt to work with each other.

For these and other reasons, there is a need in the field for an improved system or method for collaboration between optometry and ophthalmology practitioners.

### SUMMARY

In various representative aspects, the instant disclosure provides for a system, a method, and an electronic platform for the co-management of two or more healthcare practices, such as an ophthalmology practice and an optometry practice.

In one aspect, the disclosure provides for a method including retrieving an electronic health record for a patient and storing first health information for the patient corresponding to a diagnosis of the patient by the first healthcare practice. The patient is referred to the second healthcare practice in response to the diagnosis of the patient, corresponding to treatment provided by the second healthcare practice. The electronic health record and the health information are provided to the second healthcare practice, and second health information is stored for the patient corresponding to treatment of the patient by the second healthcare practice. At least one follow-up visit is scheduled for the patient at one of the first healthcare practice or the second healthcare practice. A first portion of a referral fee from the second healthcare practice is distributed to the first healthcare practice, and a second portion of the referral fee is distributed to a co-management system provider.

These and other aspects are more fully comprehended upon review of this disclosure.

### BRIEF DESCRIPTION OF THE DRAWINGS

FIGS. 1-45 are screen shots of an exemplary embodiment of an electronic platform for co-management between an ophthalmology practice and an optometry practice.

FIG. 1 is a screen shot of an exemplary menu screen of an exemplary embodiment of an electronic platform for co-management between an ophthalmology practice and an optometry practice.

FIG. 2 is a screen shot of an exemplary “Add a new patient” screen 1 of an exemplary embodiment of the electronic platform.

FIG. 3 is a screen shot of an exemplary “Add a new patient” screen 2 of an exemplary embodiment of the electronic platform.

FIG. 4 is a screen shot of an exemplary “Add a new patient” screen 3 of an exemplary embodiment of the electronic platform.

FIG. 5 is a screen shot of an exemplary “Add a new patient” screen 4 of an exemplary embodiment of the electronic platform.

FIG. 6 is a screen shot of an exemplary “Find a Patient” and “Patient List” screen of an exemplary embodiment of the electronic platform.

FIG. 7 is a screen shot of an exemplary “Patient Details” screen of an exemplary embodiment of the electronic platform.

FIG. 8 is a screen shot of an exemplary “Patient Visits” screen of an exemplary embodiment of the electronic platform.

FIG. 9 is a screen shot of an exemplary “Add Patient Visit” screen of an exemplary embodiment of the electronic platform.

FIG. 10 is a screen shot of an exemplary “Patient Procedures” screen of an exemplary embodiment of the electronic platform.

FIG. 11 is a screen shot of an exemplary “Add Procedure” screen of an exemplary embodiment of the electronic platform.

FIG. 12 is a screen shot of an exemplary “Patient Referrals” screen of an exemplary embodiment of the electronic platform.

FIG. 13 is a screen shot of an exemplary “Add Referral” screen of an exemplary embodiment of the electronic platform.

FIG. 14 is a screen shot of an exemplary “Top Referrers” screen of an exemplary embodiment of the electronic platform.

FIG. 15 is a screen shot of an exemplary “Revenue Per Product” screen of an exemplary embodiment of the electronic platform.

FIG. 16 is a screen shot of an exemplary “Clinical Metrics” screen of an exemplary embodiment of the electronic platform.

FIG. 17 is a screen shot of an exemplary “Additional Clinical Metrics” screen of an exemplary embodiment of the electronic platform.

FIG. 18 is a screen shot of an exemplary “Referral List” screen of an exemplary embodiment of the electronic platform.

FIG. 19 is a screen shot of an exemplary “Patient Revenue” screen of an exemplary embodiment of the electronic platform.

FIG. 20 is a screen shot of an exemplary “Doctor Revenue” screen of an exemplary embodiment of the electronic platform.

FIG. 21 is a screen shot of an exemplary “Fee Report” screen of an exemplary embodiment of the electronic platform.

FIG. 22 is a screen shot of an exemplary “Automatic System Generated Monthly Ophthalmologist Invoice Email” screen of an exemplary embodiment of the electronic platform.

FIG. 23 is a screen shot of an exemplary “Automatic System Generated Monthly Optometrist Credit Statement Email” screen of an exemplary embodiment of the electronic platform.

FIG. 24 is a screen shot of an exemplary telepresence screen of an exemplary embodiment of the electronic platform.

FIG. 25 is a screen shot of an exemplary embodiment of an educational page screen, depicting information on “Calhoun Light Adjustable Lens.”

FIG. 26 is a screen shot of an exemplary embodiment of an educational page screen, depicting a second page of information on “Calhoun Light Adjustable Lens.”

FIG. 27 is a screen shot of an exemplary embodiment of an educational page screen, depicting information on “Visiogen Synchrony.”

FIG. 28 is a screen shot of an exemplary embodiment of an educational page screen, depicting a second page of information on “Visiogen Synchrony.”

FIG. 29 is a screen shot of an exemplary embodiment of an educational page screen, depicting a third page of information on “Visiogen Synchrony.”

FIG. 30 is a screen shot of an exemplary embodiment of an educational page screen, depicting information on “Alcon ReSTOR.”

FIG. 31 is a screen shot of an exemplary embodiment of an educational page screen, depicting a second page of information on “Alcon ReSTOR.”

FIG. 32 is a screen shot of an exemplary embodiment of an educational page screen, depicting information on “Tetraflex.”

FIG. 33 is a screen shot of an exemplary embodiment of an educational page screen, depicting information on “NuLens.”

FIG. 34 is a screen shot of an exemplary embodiment of an educational page screen, depicting information on “VisionCare I.M.T.”

FIG. 35 is a screen shot of an exemplary embodiment of an educational page screen, depicting information on “Crystalens HD.”

FIG. 36 is a screen shot of an exemplary embodiment of an educational page screen, depicting a second page of information on “Crystalens HD.”

FIG. 37 is a screen shot of an exemplary embodiment of an educational page screen, depicting information on “Ziemer.”

FIG. 38 is a screen shot of an exemplary micro-blog screen of an exemplary embodiment of the electronic platform.

FIG. 39 is a screen shot of an exemplary “View Profile” screen of an exemplary embodiment of the electronic platform.

FIG. 40 is a screen shot of an exemplary “User List” screen of an exemplary embodiment of the electronic platform.

FIG. 41 is a screen shot of an exemplary “Add/Edit User” screen of an exemplary embodiment of the electronic platform.

FIG. 42 is a screen shot of an exemplary “Current Relationships” screen of an exemplary embodiment of the electronic platform.

FIG. 43 is a screen shot of an exemplary “Request Relationships” screen of an exemplary embodiment of the electronic platform.

FIG. 44 is a screen shot of an exemplary “Request Relationships” screen 2 of an exemplary embodiment of the electronic platform.

FIG. 45 is a screen shot of an exemplary “Coming Soon” screen of an exemplary embodiment of the electronic platform.

FIG. 46 is an illustration of two business entities comprising a shared co-management system.

FIG. 47 is a flow chart showing an overview of a process for referring out a client from the perspective of business entity A.

FIG. 48 is a flow chart showing an overview of a process for receiving an incoming referred client from the perspective of business entity B.

FIG. 49 is a flow chart showing an overview of a process for calculating a referral fee from the perspective of business entity A.

FIG. 50 is a flow chart showing an overview of a process for calculating a referral fee from the perspective of business entity B.

FIG. 51 is a block diagram illustrating the modules/means/components of a shared co-management system.

FIG. 52 is a diagram illustrating a hardware implementation for a shared co-management system between two business entities employing a processing system.

FIG. 53 is an illustration of a Cloud/Web based portal accessible by mobile/desktop/laptop devices showing various exemplary embodiments.

FIG. 54 is a flow chart showing an overview of a process for marking a client as referred in a Co-Management System.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

An exemplary embodiment provides a bridge between respective optometry and ophthalmology practices. Among other things, the system provides a network for referrals, for advanced education, for managing money, and for providing continuity models and analytic models, as will be described below in further detail.

Various embodiments may be implemented utilizing computers, terminals, smart phones, or any suitable workstation at one or more of an optometrist's office, an ophthalmologist's office, a patient's home, or any other suitable location. One or more of these workstations may be coupled to a network for communication, such as the Internet. Various suitable security measures known to those skilled in the art may be implemented to keep patients' health records private.

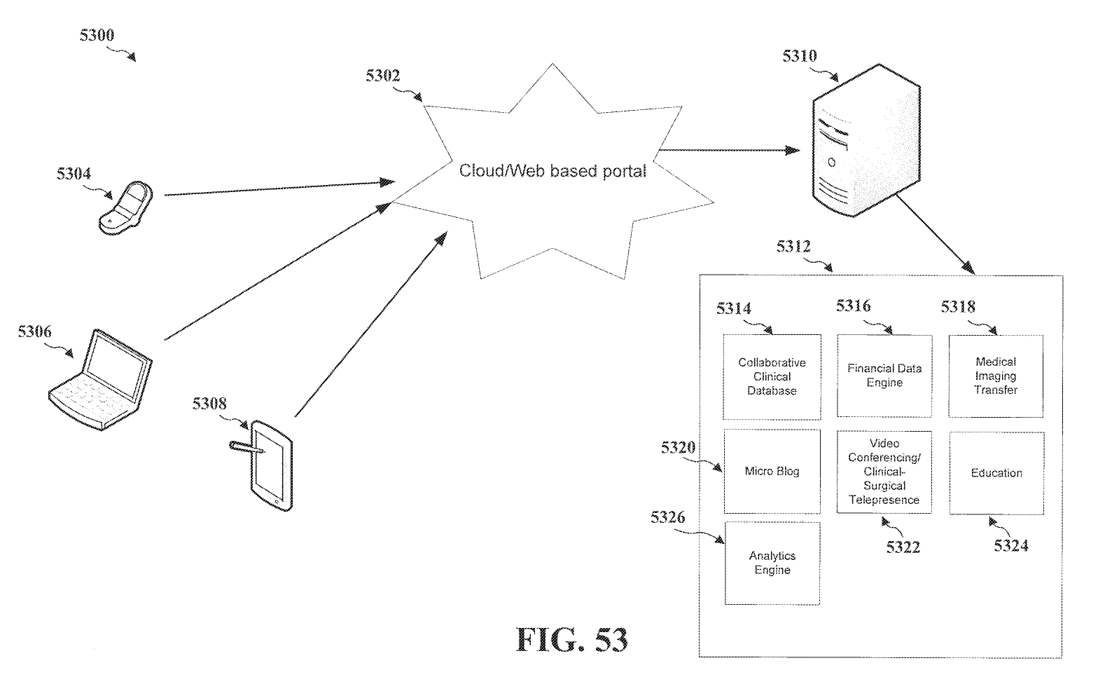

The service may include a web-based platform that optometrists, ophthalmologists, 3^{rd} party vendors, health care providers, and surgical technology companies can plug into to take part in the clinical and commercial partnerships realized by the utilization of this platform. With the platform, electronic partnerships can form and flourish, aggregate, become cognitive, and improve as commercial and clinical values increase with rate and degree of utilization. FIG. 53 is an illustration 5300 of a Cloud/Web based portal accessible by mobile/desktop/laptop devices showing various exemplary embodiments, among others.

Location: Cloud/Web based portal 5302 is accessible by mobile/desktop/laptop devices. Each of the devices such as the mobile device 5304, computer 5306, or tablet device 5308 may have access to the cloud/web based portal 5302. The cloud/web based portal 5302 may be connected to a server 5310 to store all the data required to run the service.

The system captures clinical and commercial data needed for multiple disparate clinical and commercial entities to exist within one system and generate additional commerce and/or revenue among the entities and the newly created platform (including supporting new forms of commerce generation).

The system is agile, scalable, and secure to meet the ever-changing technology landscape, new technologies, HIPAA level accreditation, and changes a collaborative system will face.

According to a further exemplary embodiment, the co-management tool may be a comprehensive clinical/commercial tool that may be considered as an ecosystem. That is, a plurality of features or icons within the platform may have a synergistic relationship, and as a whole, create a harmonization effect for the flow of information.

Various exemplary embodiments include one or more of the following components or icons, as shown by 5312 which is tied to the server 5310.

Icon #1 shown as 5314: Collaborative Clinical Database.

Currently, there are a number of disparate Electronic Health Record (EHR) platforms, and the degree of utilization is very low within the eye care community and medicine at large. No clear market leader has emerged. Some services are for pay, while the majority of EHR platforms are free and require no licensing agreements—the companies simply want their platform utilized and moving data so they can recoup costs with advertising and emerge as a market leader when this platform is fully utilized and mandatory.

Database 5314 may be an open source platform for clinical data, which captures written chart notes, electronic patient data, and any other data necessary for a collaborative platform to measure the pre-operative, operative, and post-operative data for every co-managed patient. In terms of scalability, this component may also record and catalogue video of these procedures as well as the written and electronic information for each patient.

One of the opportunities with this component is developing an open, collaborative database 5314 that acts as a bridging tool before the EHR movement is fully utilized and mandatory among insurance and medical agencies. In many ways, this can be the first exposure to an EHR platform-lite for many optometrists and ophthalmologists. A system such as this that accepts all forms of written-capture data (either through Livescribe or high speed PDF scanner) and different EHR platforms would provide a significant market advantage.

Financial Data Engine 5316 may measure the transfer of payments between entities and sort ongoing payments by patient name, type, technology type, disease state, facility location, etc. In some embodiments, an account is established for a healthcare provider, and referrals from that healthcare provider to another provider result in portions of the fees paid by the patient to the second provider are credited to the account as referral fees. Medical Imaging Transfer module 5318 may include the transfer of medical grade images, x-rays, scans, etc. from one user to another.

Micro Blog module 5320 may be an internal Twitter-like (e.g., blogging or micro-blogging) application that enables the transfer of micro-blogged information. This provides for the collective clinical growth of all entities involved in this platform. It also provides for information capture and participation for both clinicians and patients at separate locations, and also at the location connected to a blog or associated website of the collective practice of clinicians using this platform.

Video Conferencing/Clinical-Surgical Teleprescence module 5322 may enable one-touch video conferencing and teleprescence technology for office-to-office consultations, e.g., from optometrist to ophthalmologist, from optometry patient to ophthalmologist, or from clinician to site administrator.

Education module 5324 may include an education area that houses links to categorized surgical videos, new technology websites, and posted reference material content to enable both ophthalmologists and optometrists to educate themselves, their respective staff, and patients. Here, new technology companies may post their material, events, videos, etc. for access by those users.

Analytics Engine 5326 includes a cognitive part of the platform that measures, identifies, categorizes, and makes recommendations on the clinical streams of information that pass through this collaborative platform. This enables national-level speakers to augment their clinical research and publish clinical findings on the analytic yields. Further, this component enables the formation and measurement of the hybrid optometry-ophthalmology advanced technology practice that is essentially forming as a result of the participation in this platform.

Pattern Recognition Engine 5328 includes a data driven methodology for aggregating and utilizing pooled (co-managed) clinical, financial, performance, and organizational information streams to identify trends, intelligence, and previously undiscovered patterns within the datasets. Alternatively, the Analytics Engine 5326 may perform the same functions at the Pattern Recognition Engine 5328.

Further embodiments may include automated analysis of healthcare information to automatically determine the ophthalmologist or other healthcare practice to send the patient to for specialized service.

Further embodiments may include a click-wrap agreement wherein, before an ophthalmologist joins a referral network, he or she must agree to certain terms, including the automated direction of referral fees to the referring practitioner, and an agreement to direct the patient back to the referring practitioner when it is not necessarily in the patient's interest to return to the ophthalmologist for follow-up treatments or post-operative care.

Further embodiments may include automated scheduling of follow-up treatments or post-operative care when the patient is treated by the ophthalmologist. For example, when an operative procedure on a patient requires a certain number of post-operative visits, the system may schedule these visits at one or more of the optometrist who referred the patient to the ophthalmologist, or to the ophthalmologist. In some embodiments, because patient information is entered into the system each time the patient visits one of the practitioners, the referring optometrist receives information from the system to alert them if and when the patient returns to the ophthalmologist, and/or when the patient apparently misses a scheduled follow-up appointment. In this way, the ophthalmologist can retain a certain level of control over a patient, and monitor a patient even though the patient has been referred to another practitioner.

Further embodiments may include modules to enable an ophthalmologist to partner with other ophthalmologists, and to refer patients to other ophthalmologists in a condition of surgery overflow, that is, when the ophthalmologist is unable to schedule all of their referrals. In this way, a practice may be combined among a relatively large number of practitioners.

Further embodiments may include a platform for cooperative surgical procedures, in which an ophthalmologist or other surgeon utilizes an augmented reality system. In such a system, the surgeon, who is performing a surgical procedure on a patient, utilizes glasses or a visor that enable the viewing of information from various sources while viewing the patient undergoing the surgical procedure.

For example, the surgeon may view text including instructions for performing a particular procedure. As another example, the surgeon may view video of prior successful procedures, or even prior unsuccessful procedures to see what not to do. As another example, the surgeon may view streaming video from remote physicians, surgeons, or any other suitable party who may be able to provide useful information to the surgeon.

In some embodiments, the surgeon may also be provided with an audio interface, from which audio information can be provided to the surgeon, such as oral instructions, feedback from remote parties (e.g., other surgeons), or any other suitable audio information that the surgeon may find useful.

In some embodiments, a microscope or other video capture device may capture the surgical procedure performed by the surgeon and provide the video information to various remotely located parties so that they can view the surgical procedure. Some embodiments may further capture and send audio information, including the surgeon's voice, along with or in addition to the video data. In this way, remote parties may view the procedure and assist the surgeon, instruct the surgeon, and/or monitor the procedure. For example, interested parties such as insurance companies interested in a surgical procedure being performed on a high-value, or highly-insured individual such as a professional athlete, may wish to view the procedure to verify that it is being performed properly. In certain of these embodiments, the video information being captured and sent is high-grade medical quality images.

In some embodiments, the surgeon wears gloves including motion capture sensors during the performance of the surgical procedure. In some embodiments, remote physicians, teachers, and/or students wear similar gloves. In some embodiments, the gloves also include actuators to provide tactile feedback or to actively move the surgeon's hand or hands. In this way, a team of surgeons may perform a surgical procedure in tandem, enabling the collective intelligence of a number of parties to perform the surgical procedure. Thus, the likelihood of a mistake by an individual surgeon is reduced, improving the likelihood of a successful procedure.

In some embodiments, the cooperative surgical platform enables multiple parties to collaborate during pre-operative, operative, and/or post-operative procedures.

In some embodiments, information captured by the video and/or audio detectors, or information provided by one or more of the interfacing parties, is utilized by the system as a basis for an automated analysis and/or diagnosis based on information in a database.

In some embodiments, the interface for video, audio, or tactile information includes a network interface, sending information, for example, through the Internet.

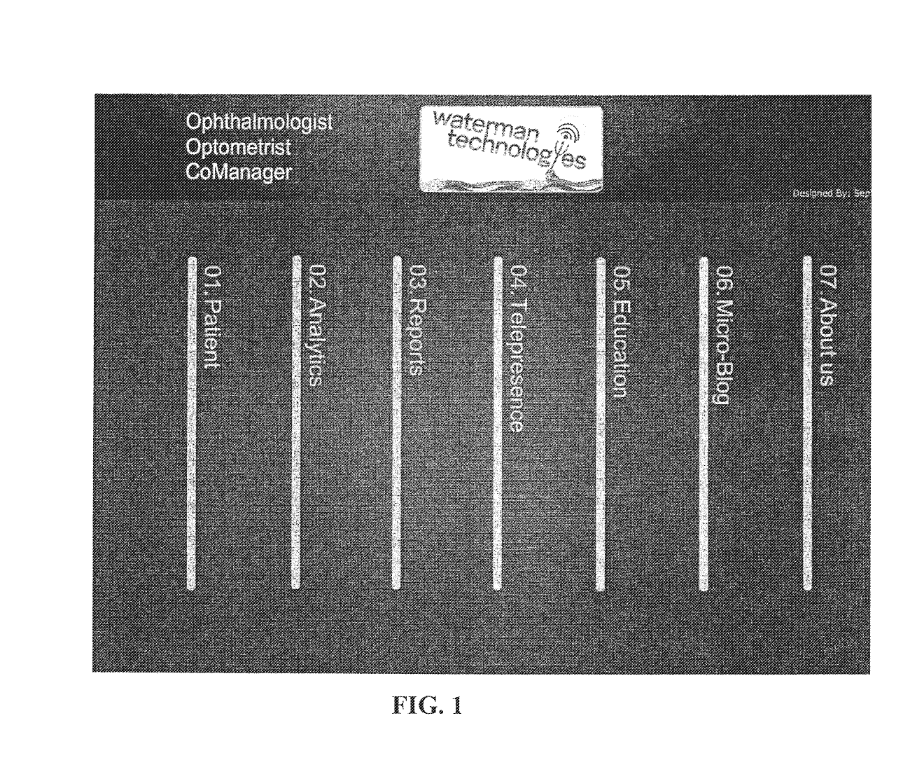

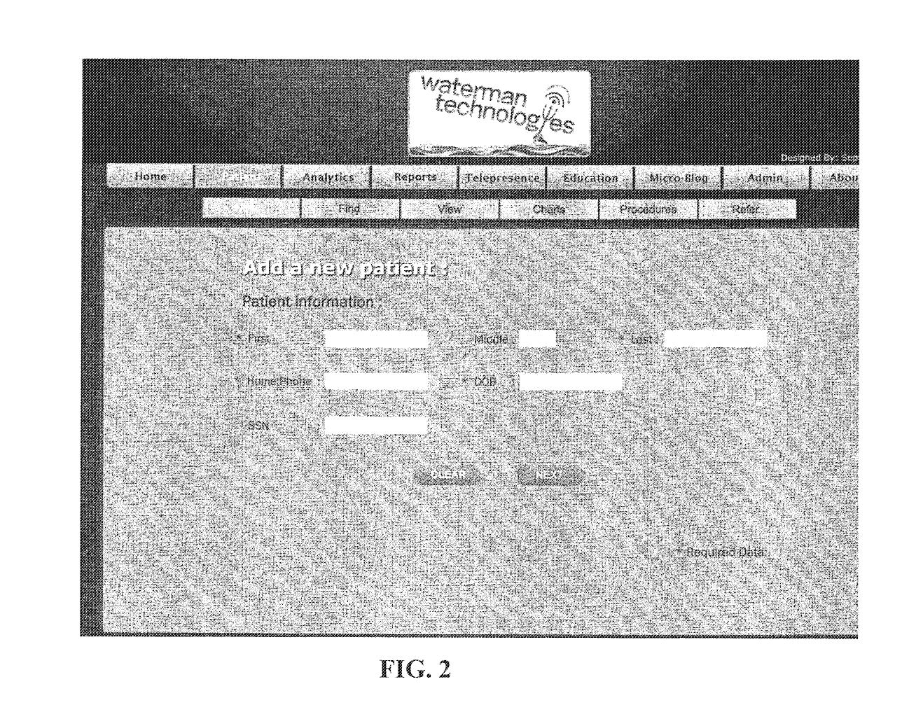

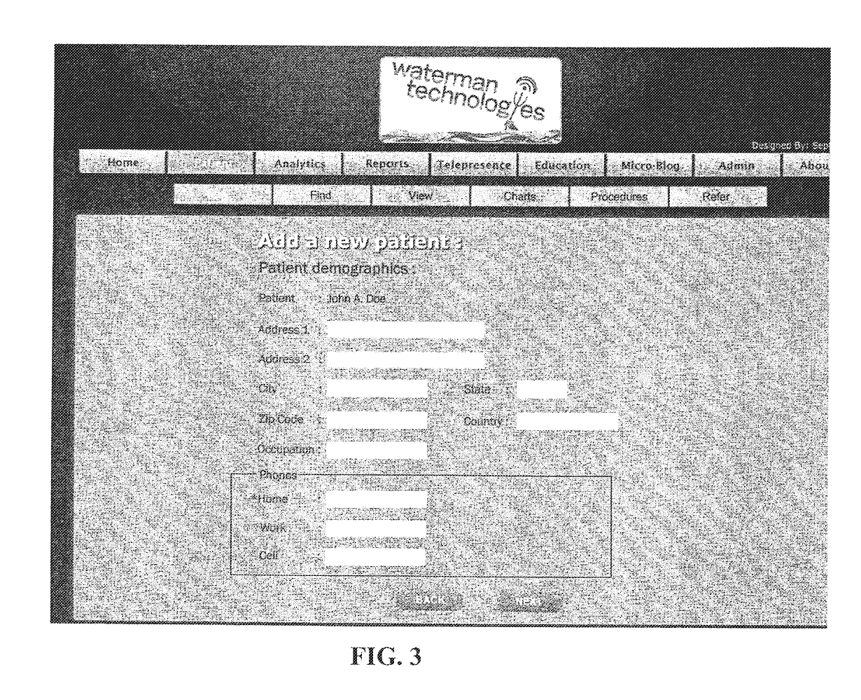

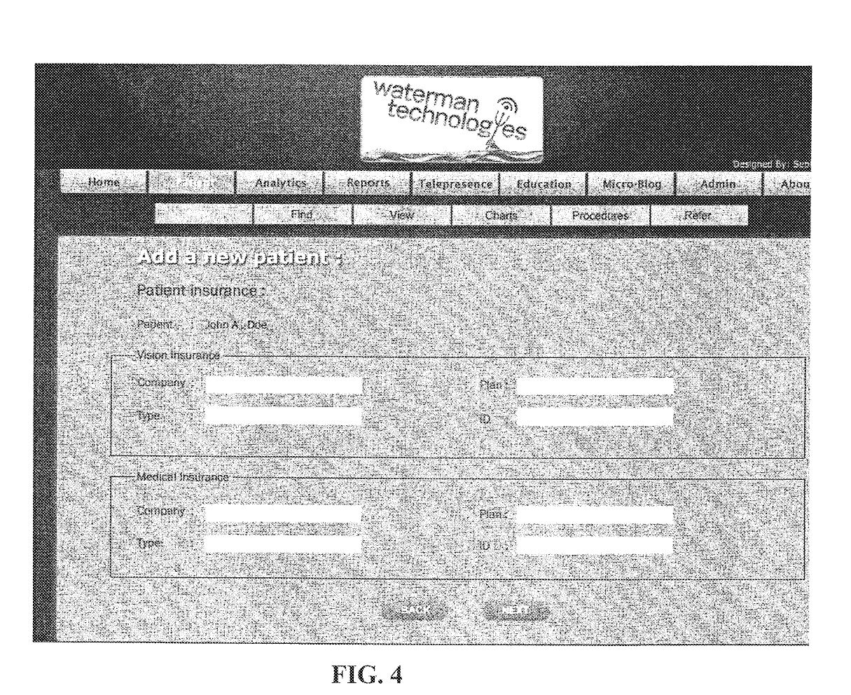

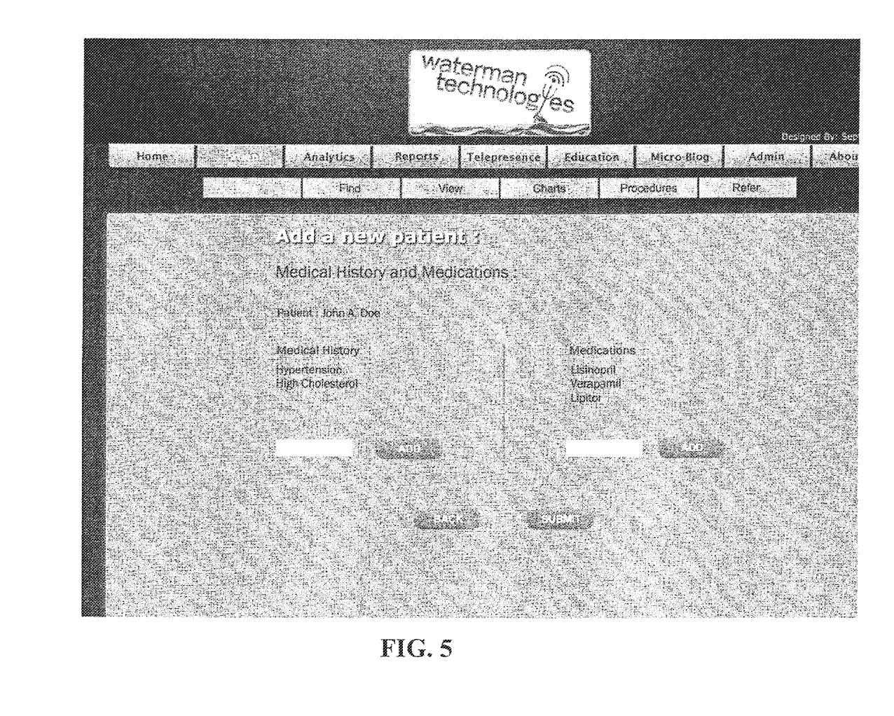

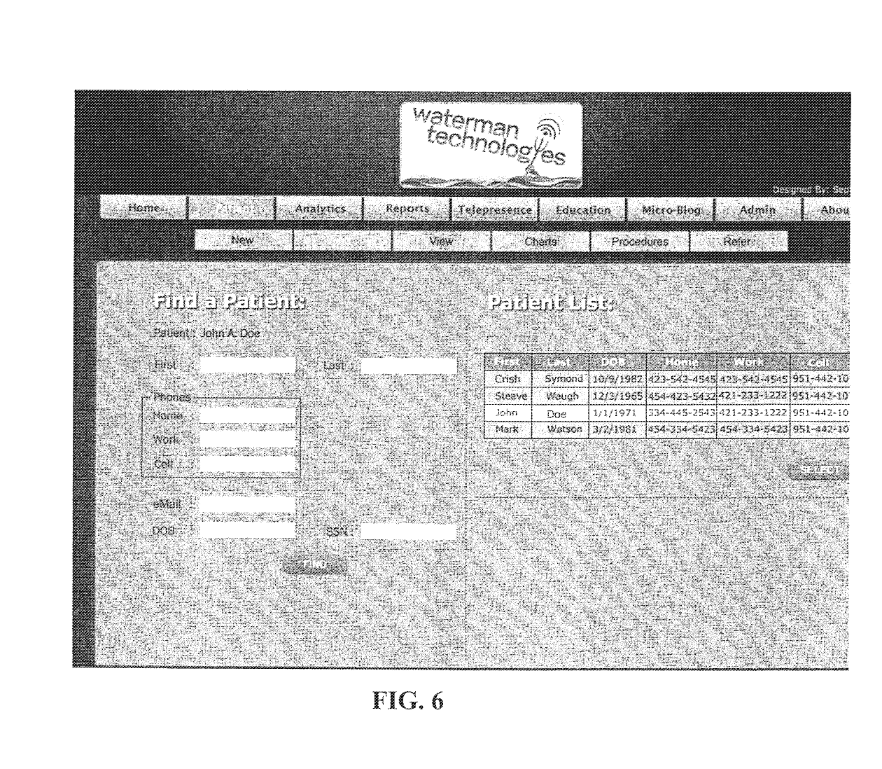

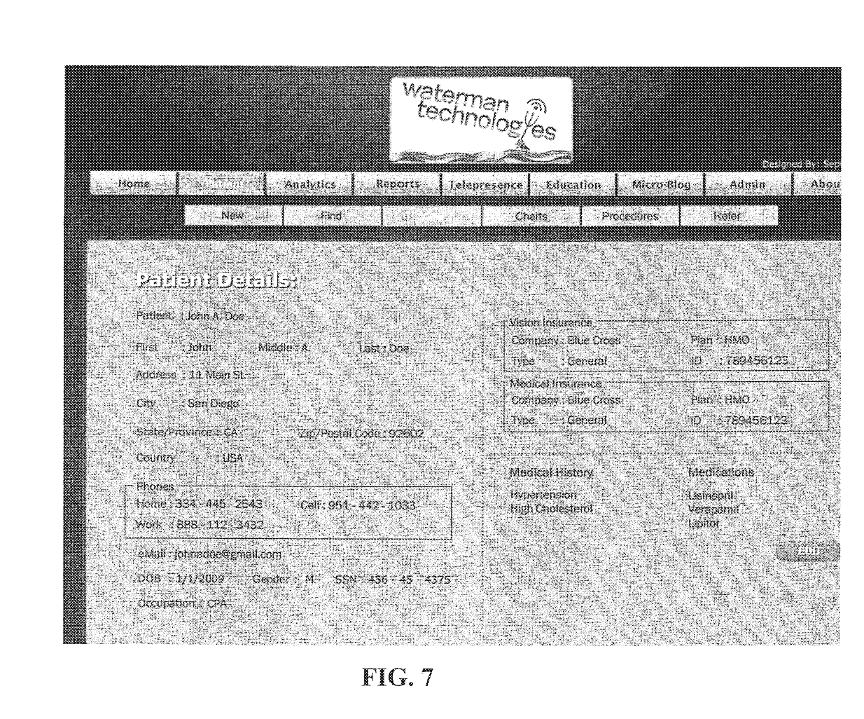

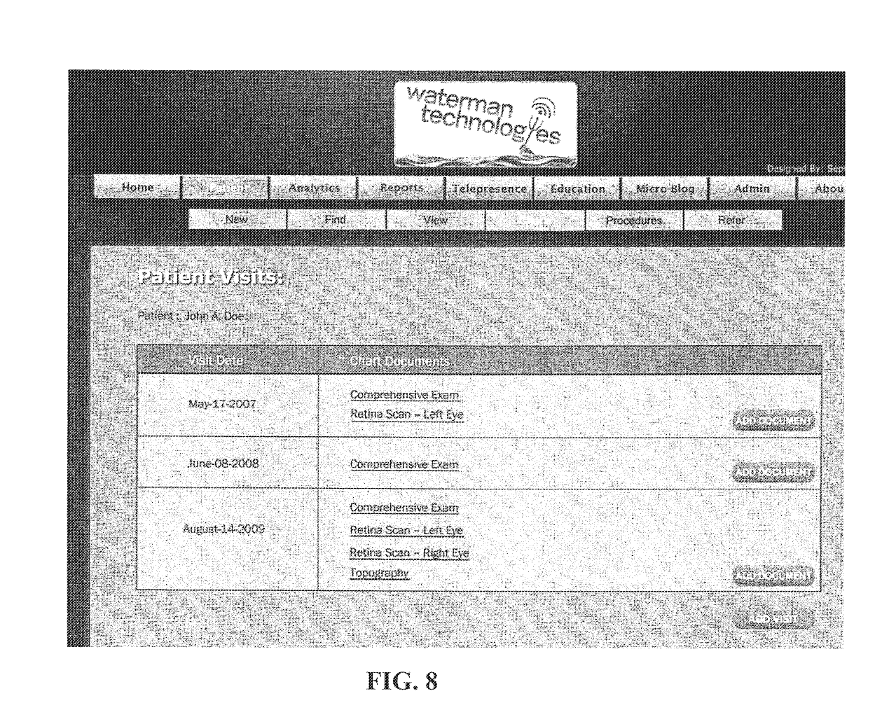

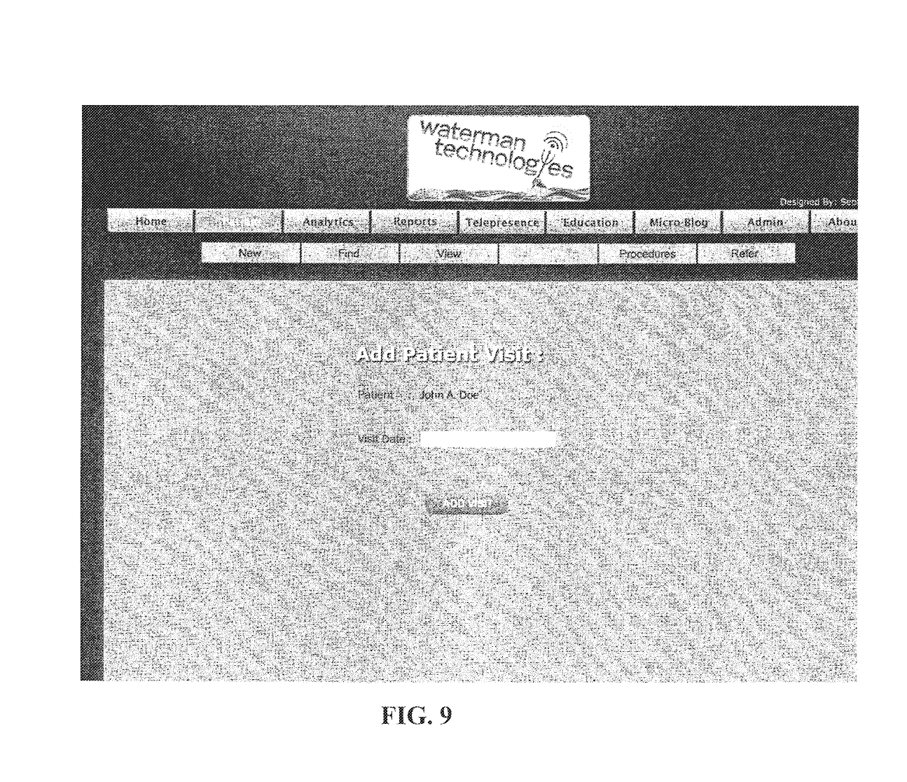

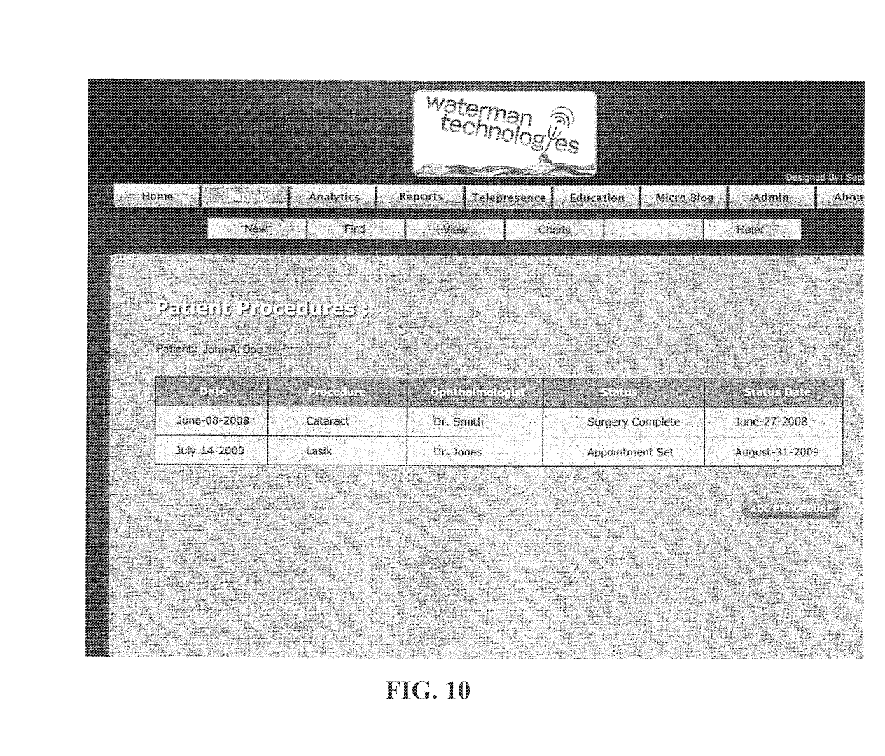

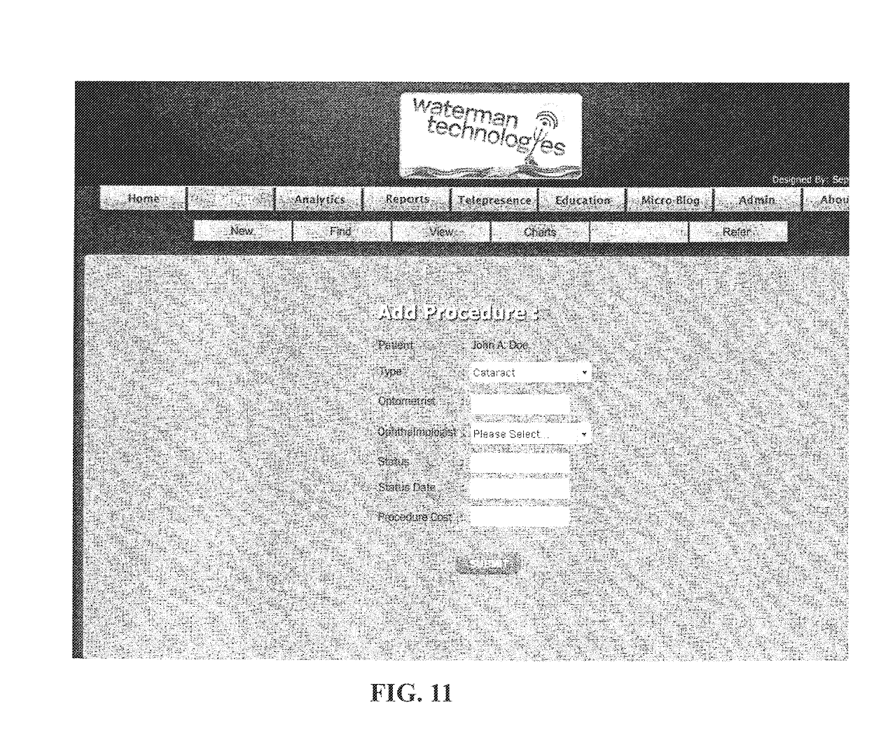

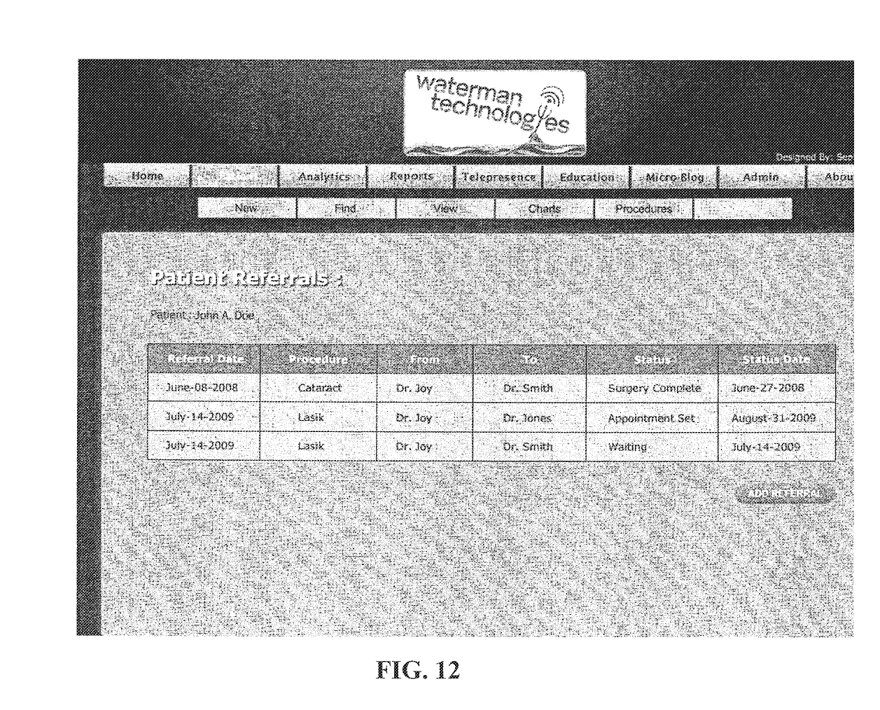

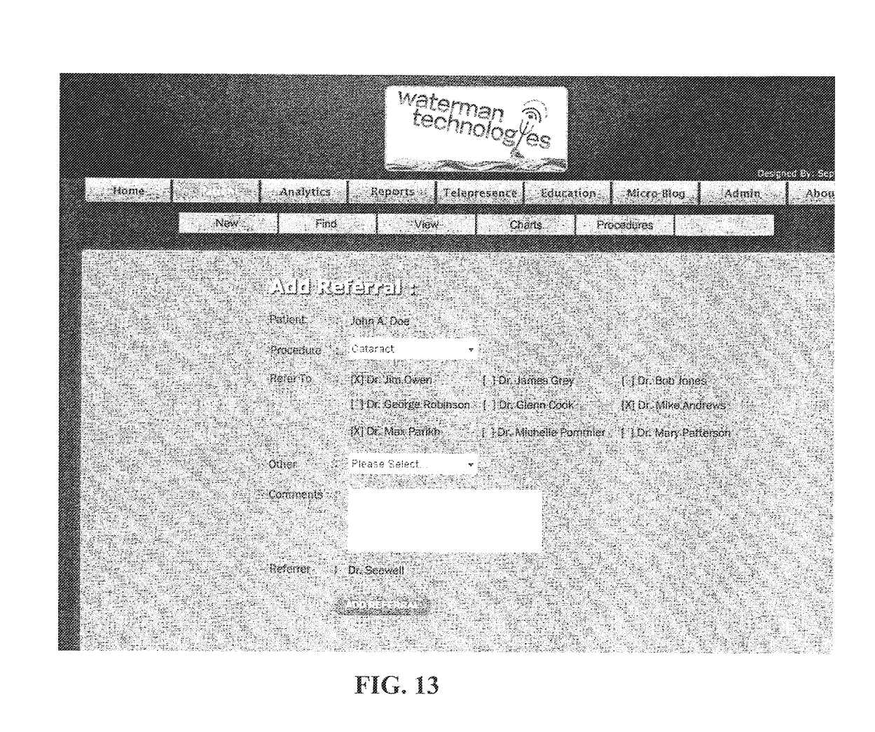

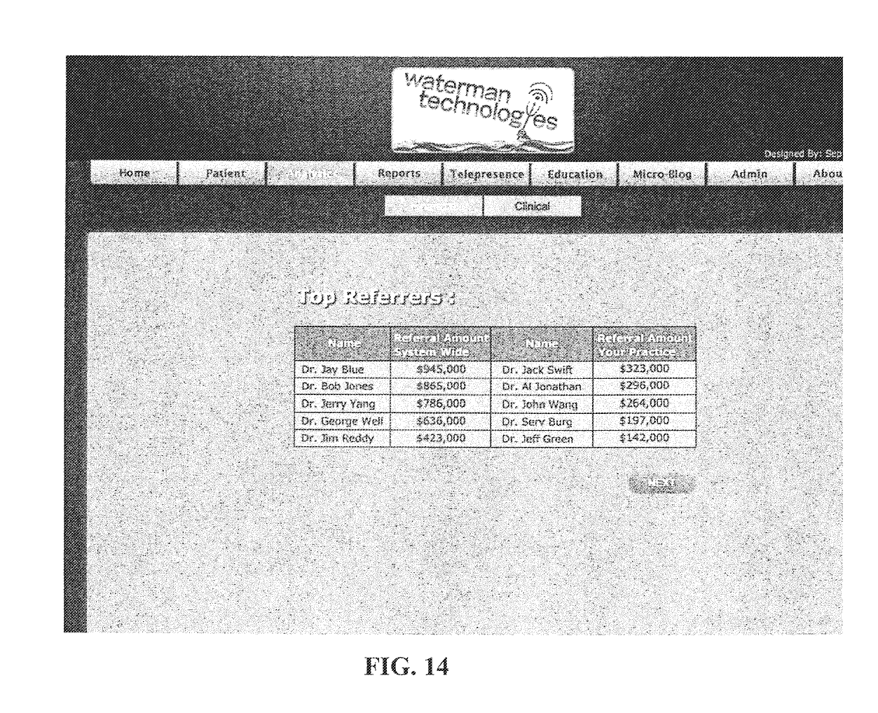

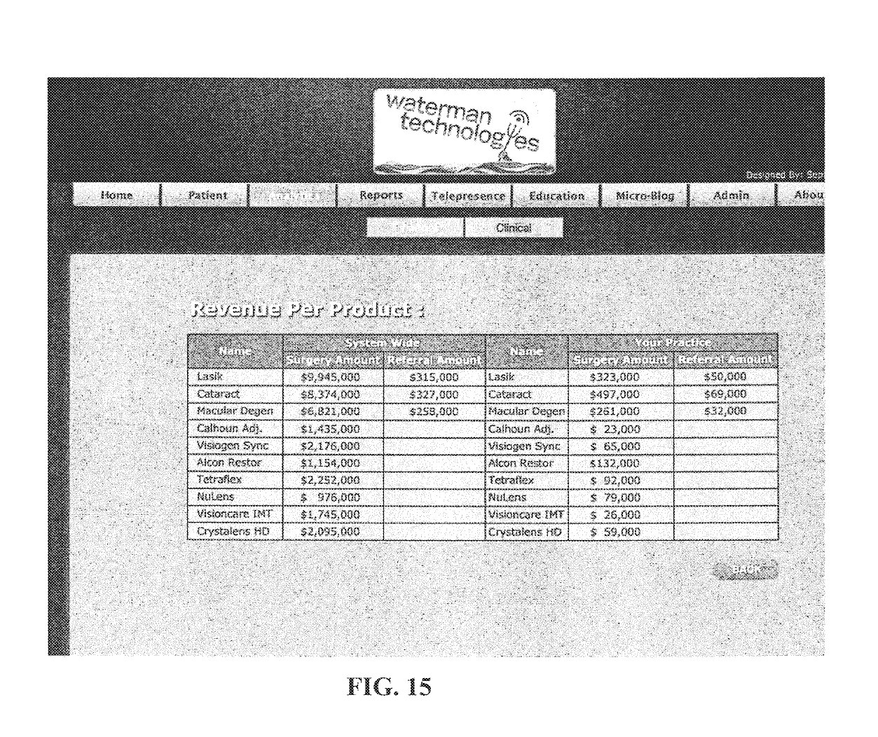

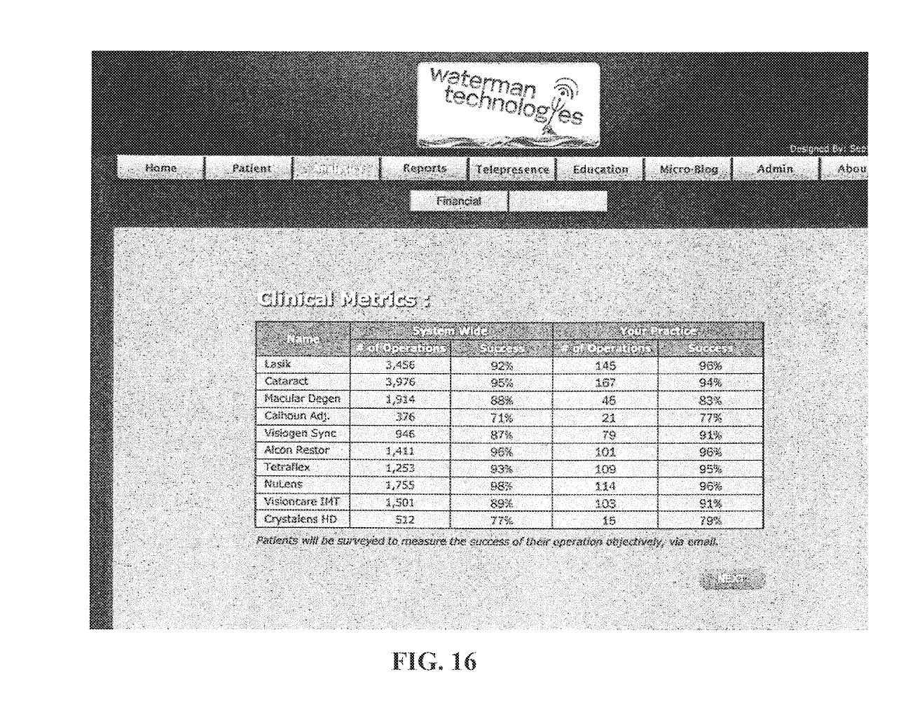

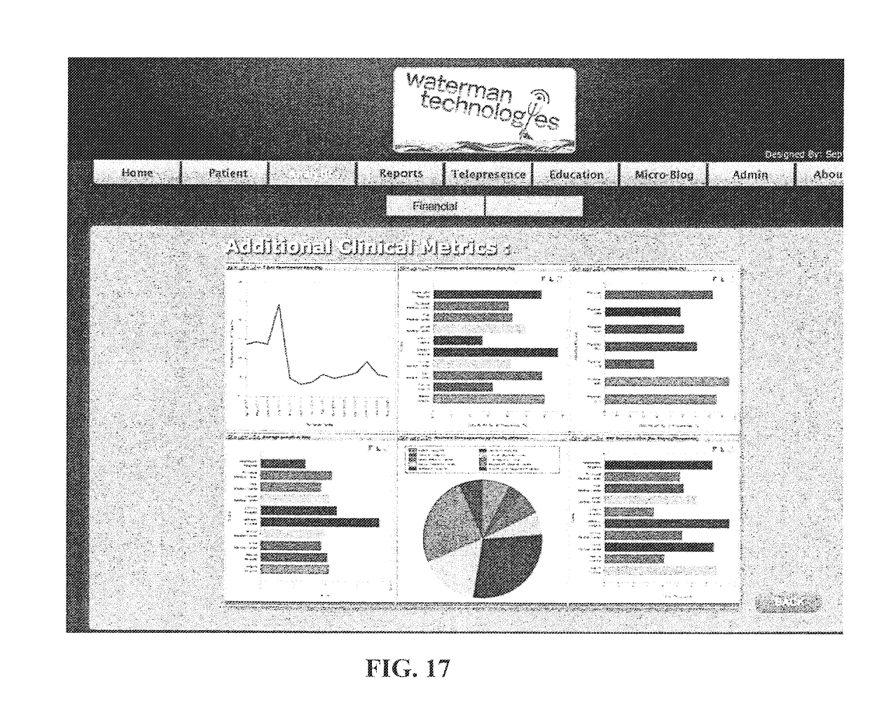

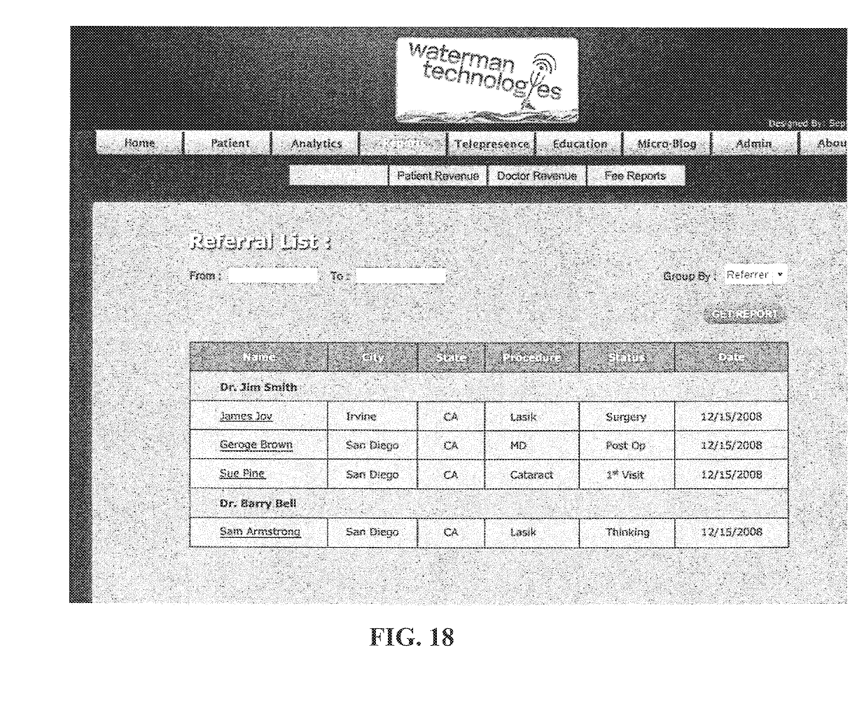

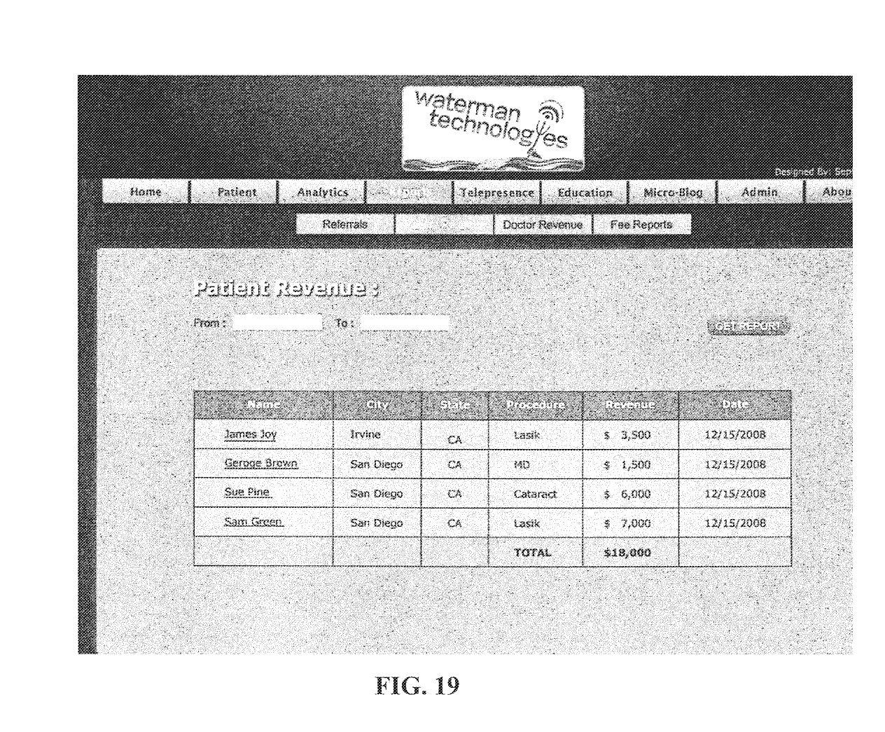

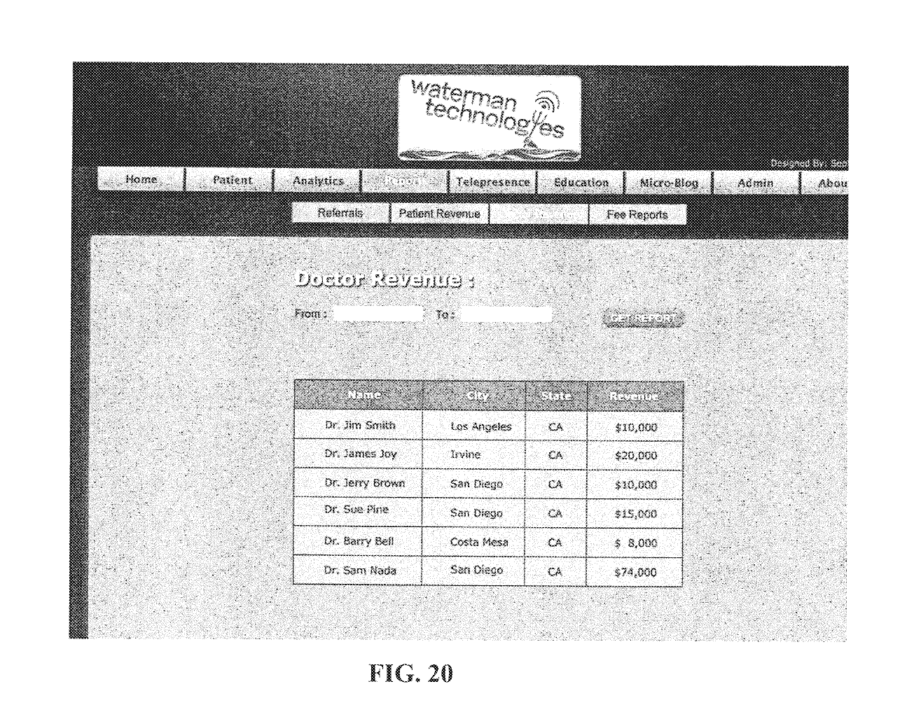

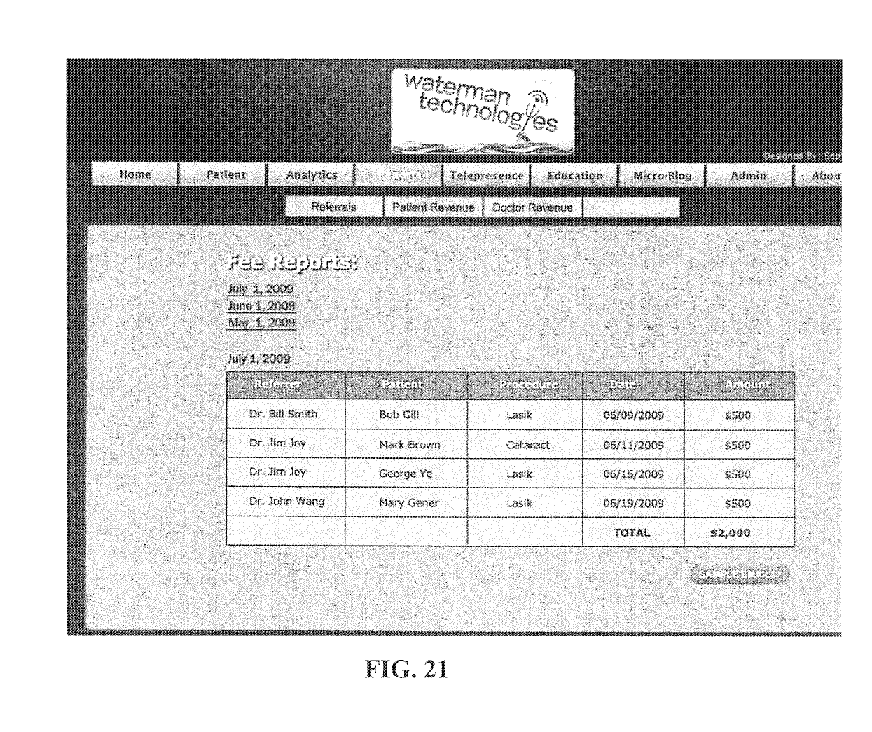

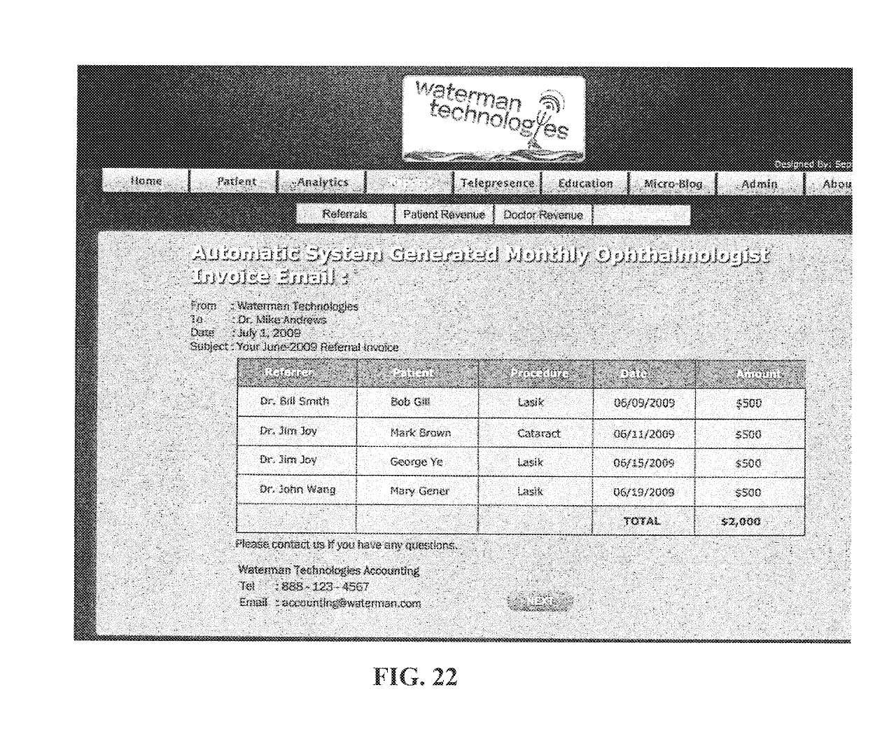

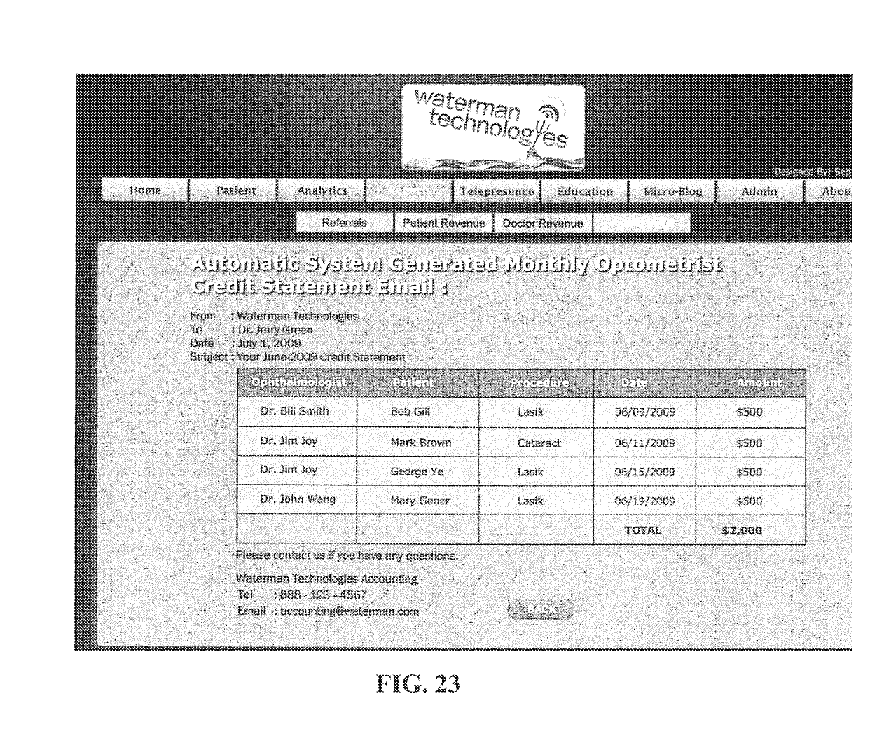

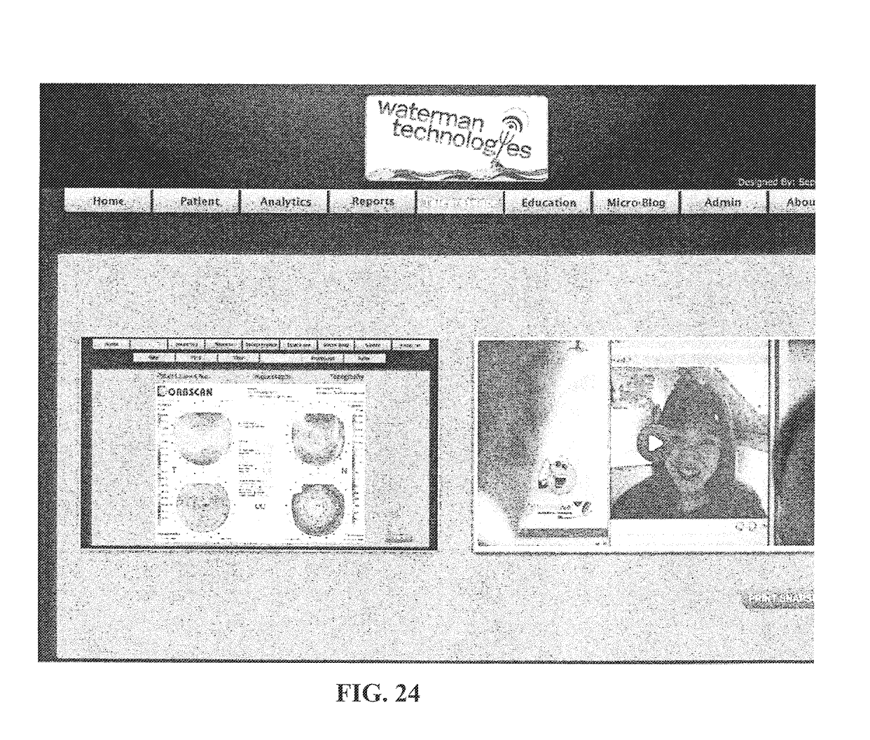

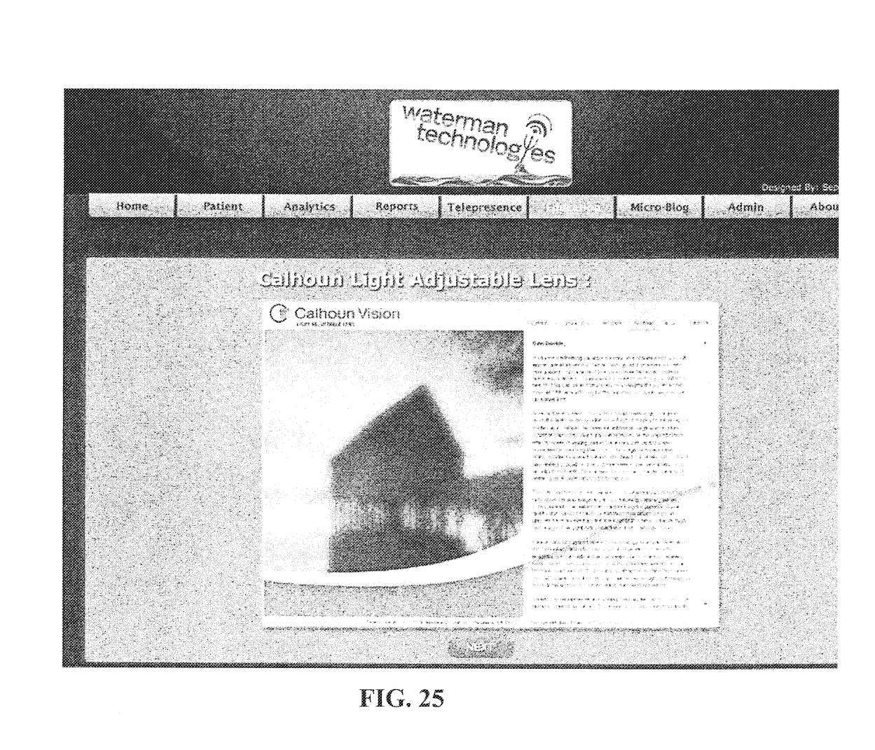

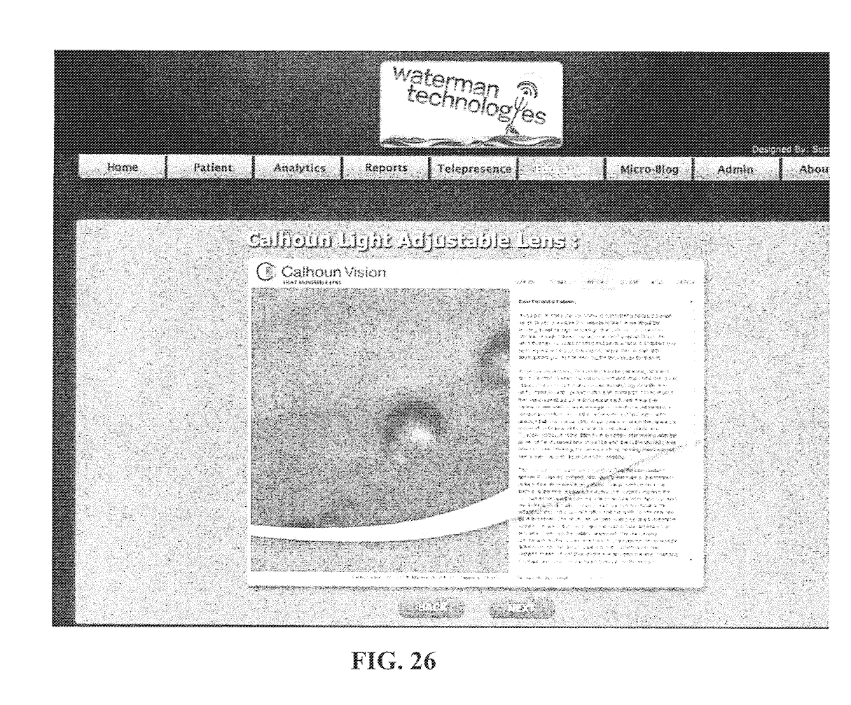

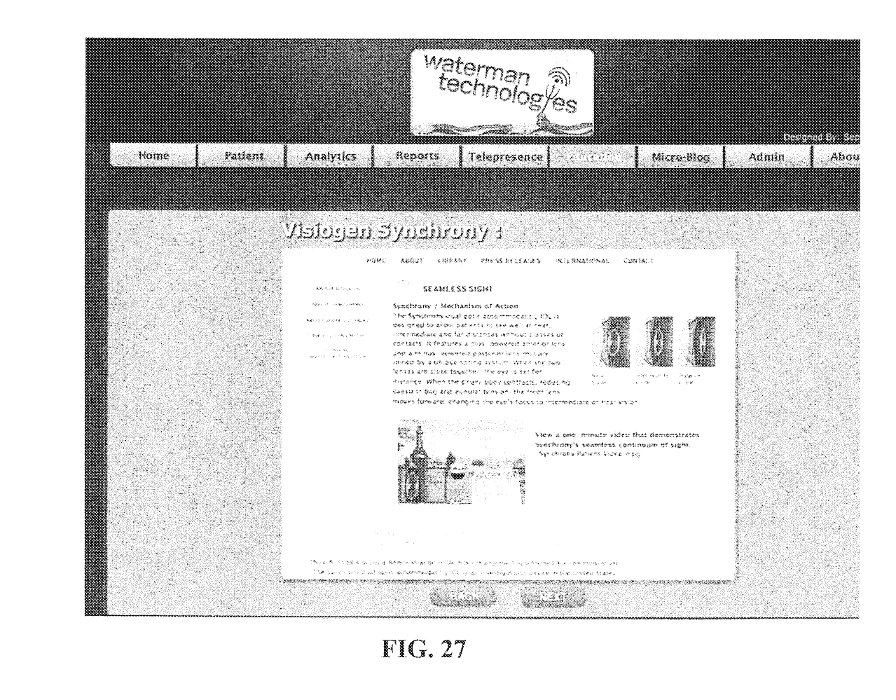

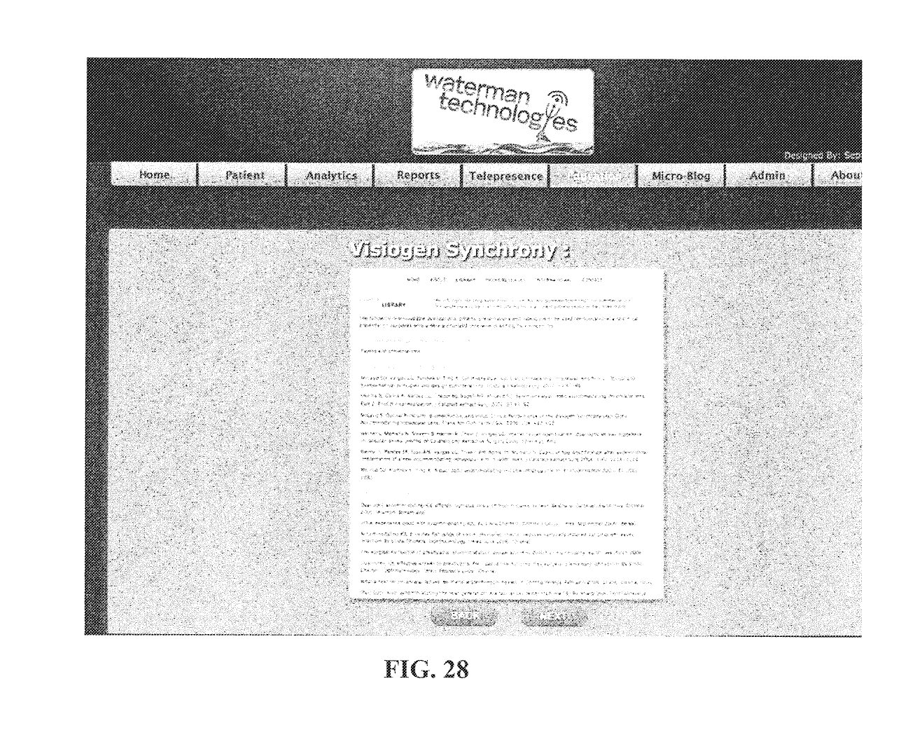

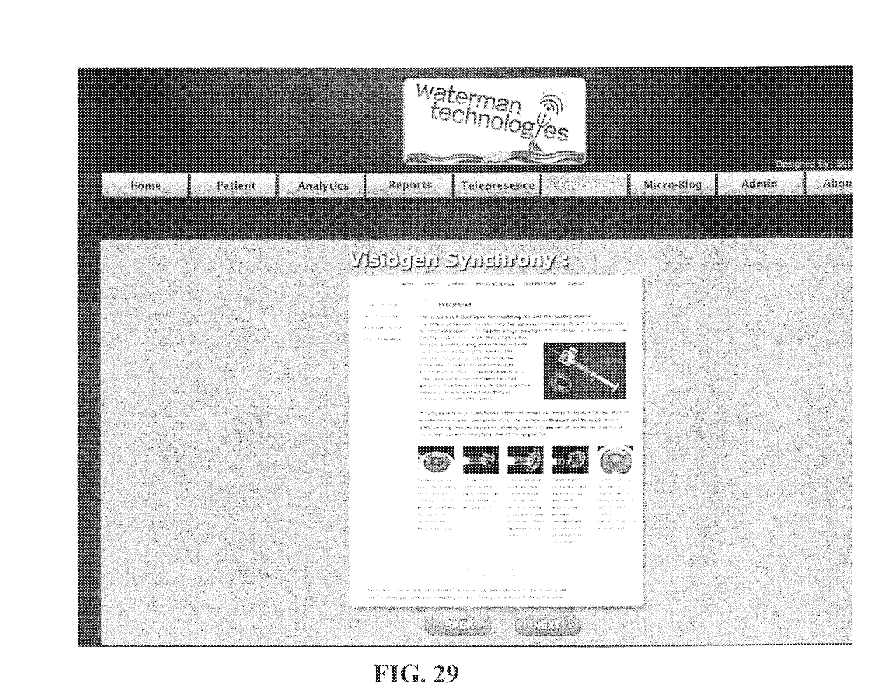

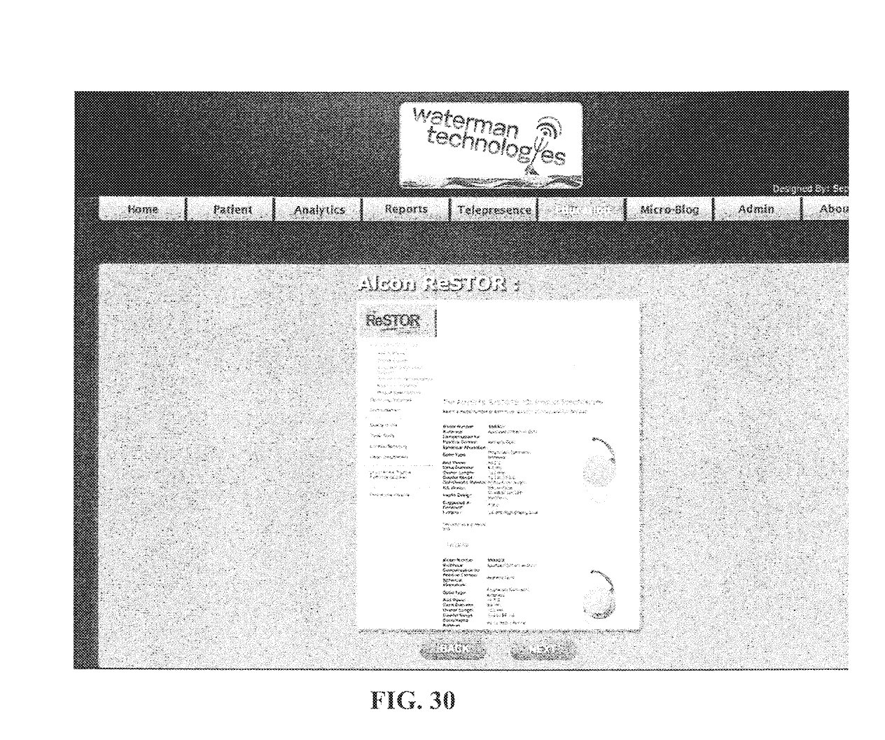

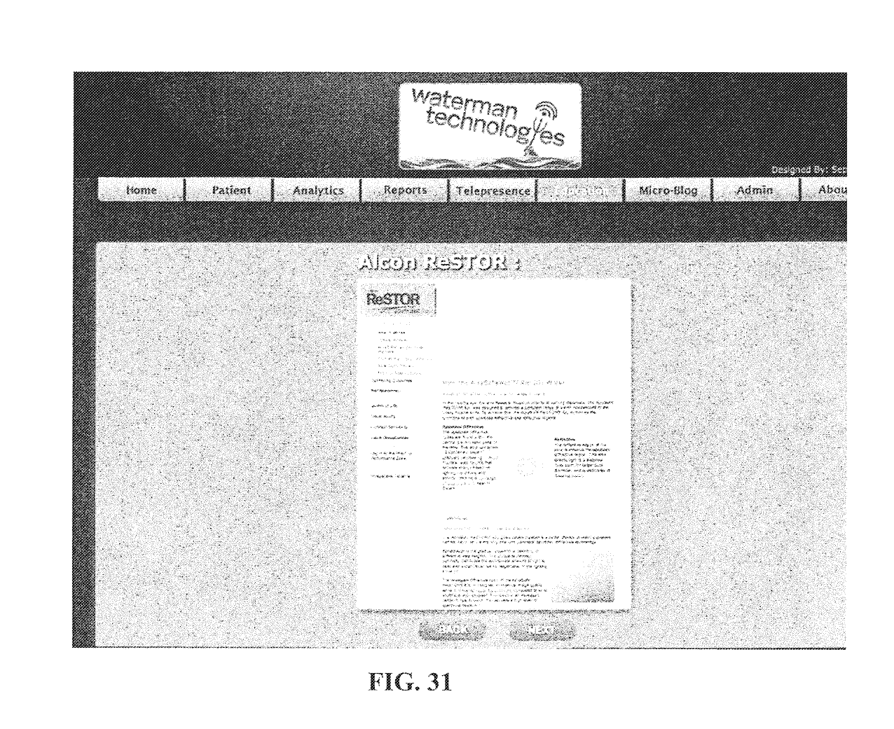

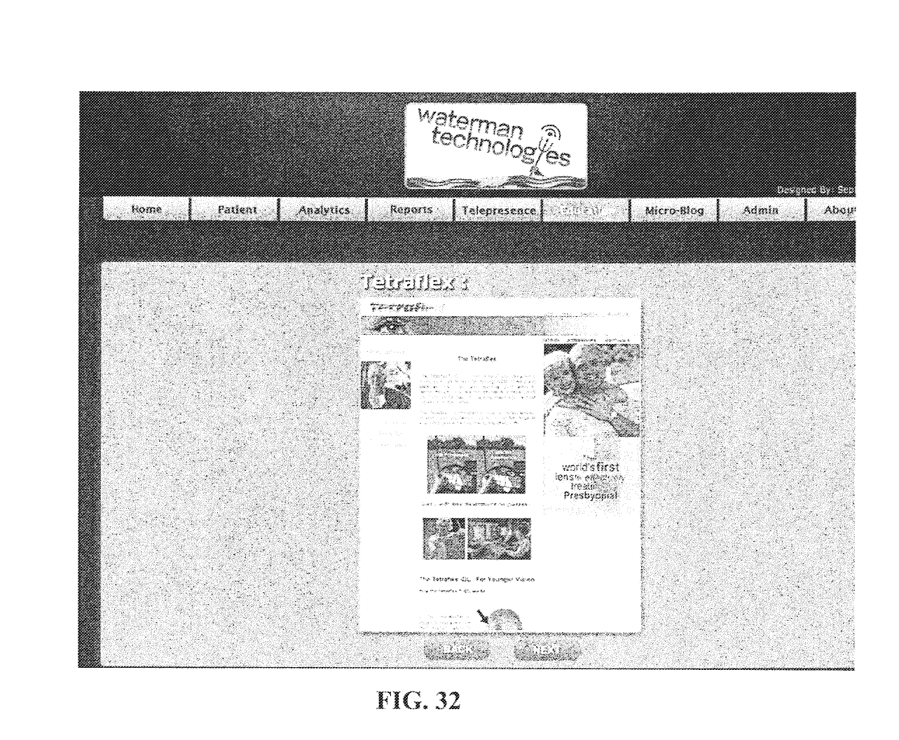

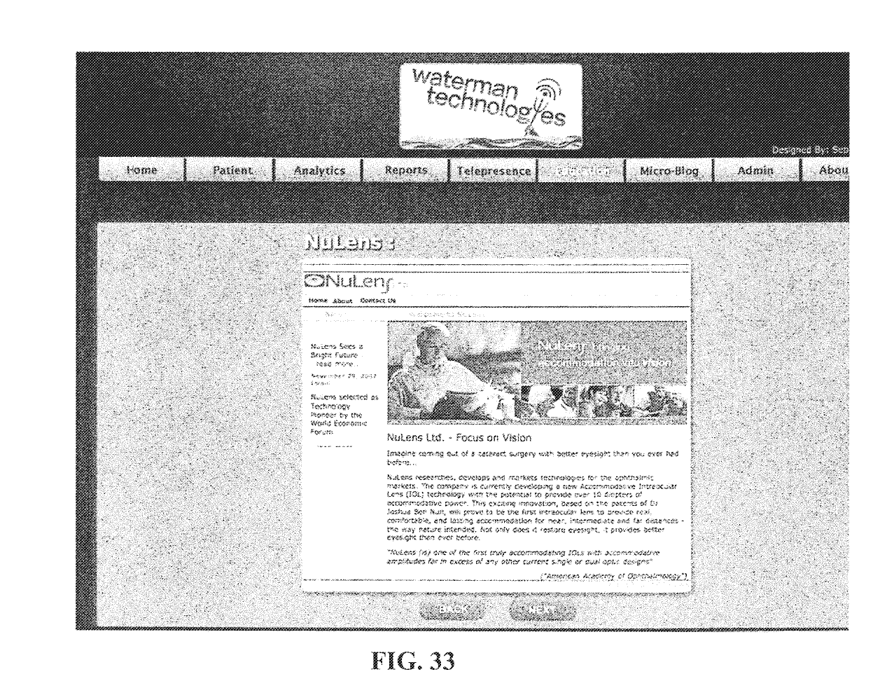

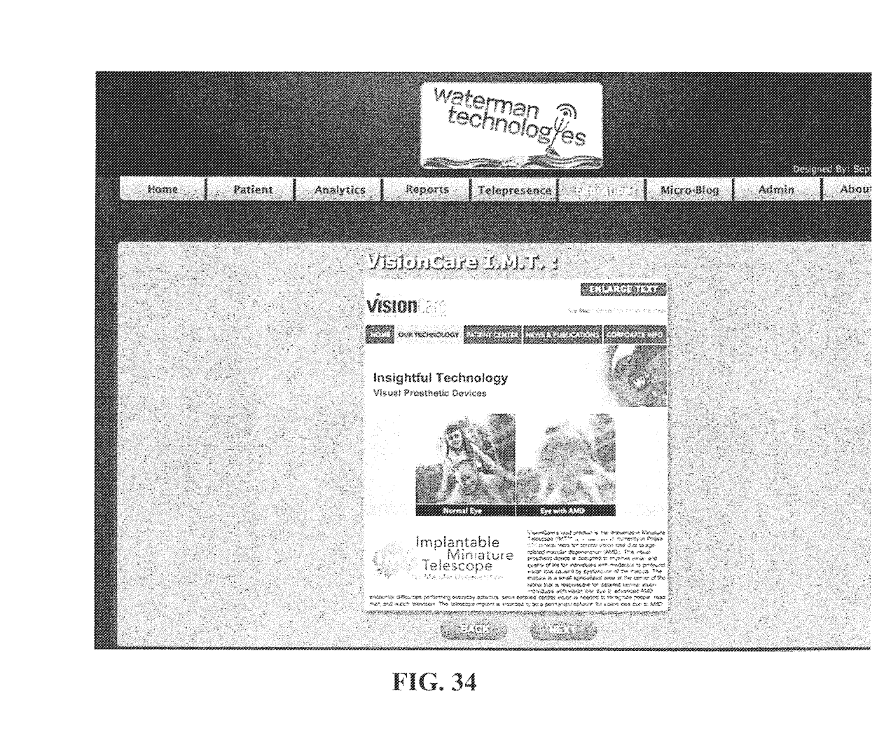

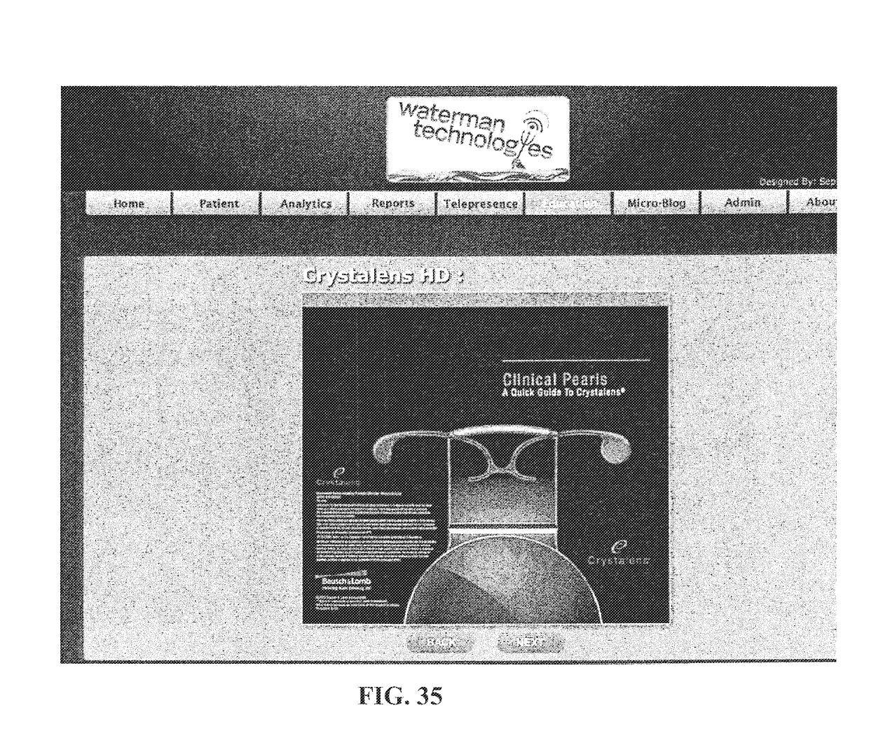

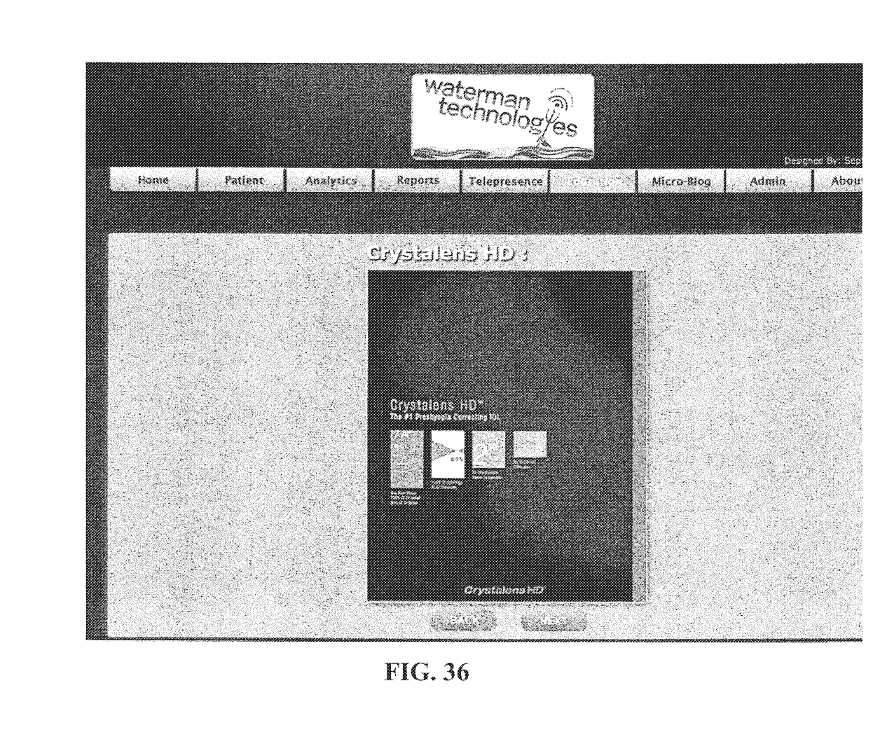

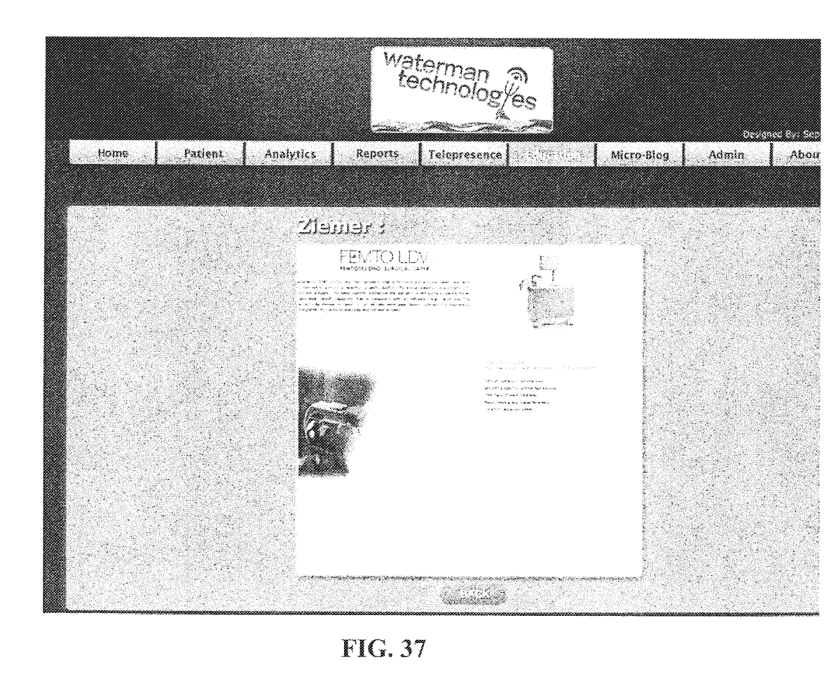

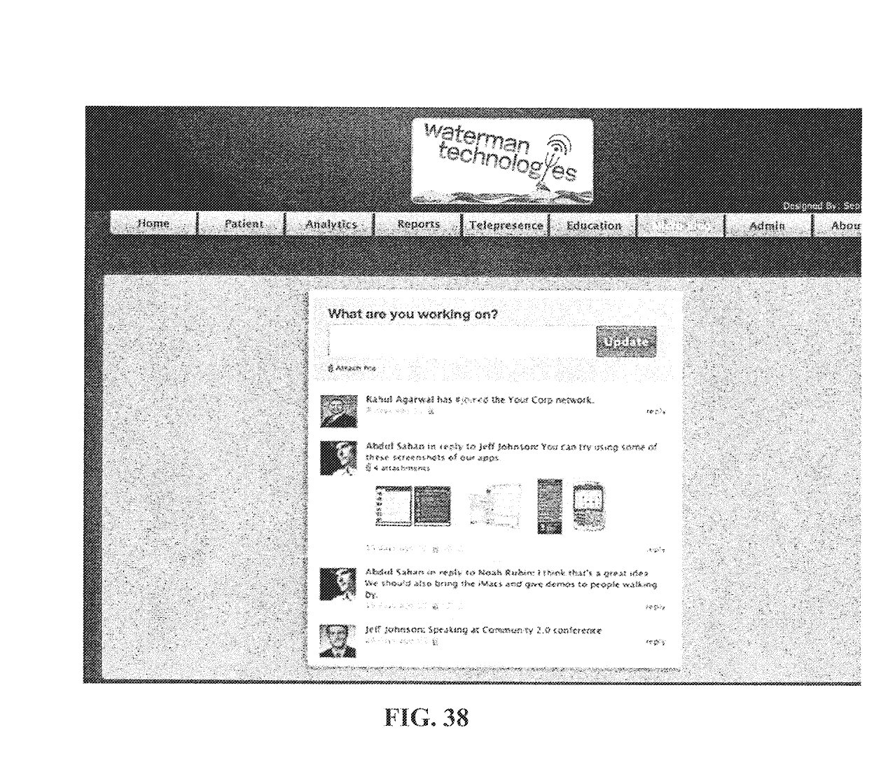

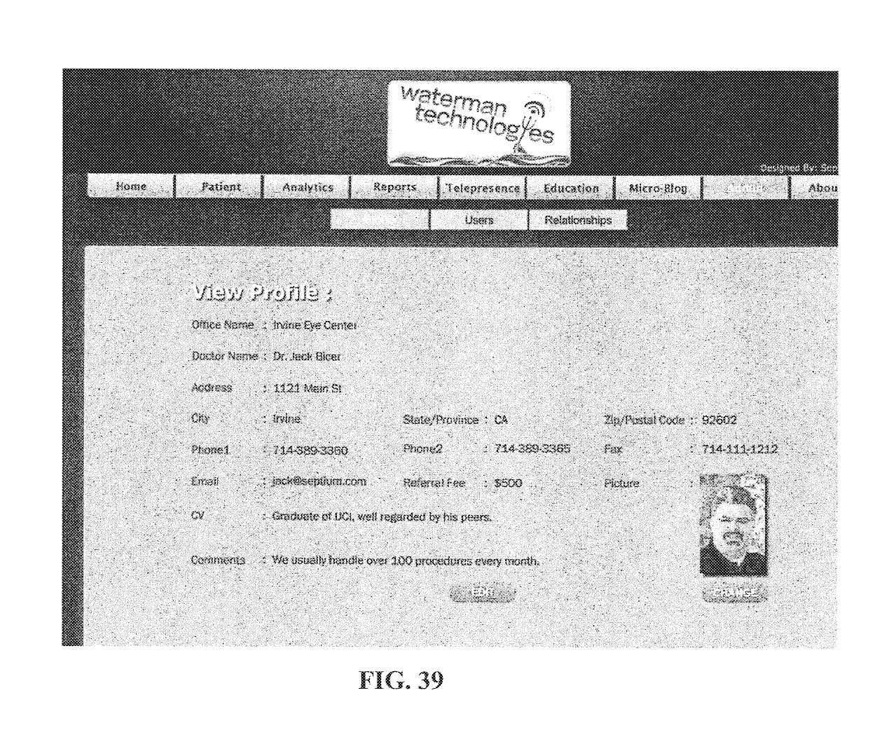

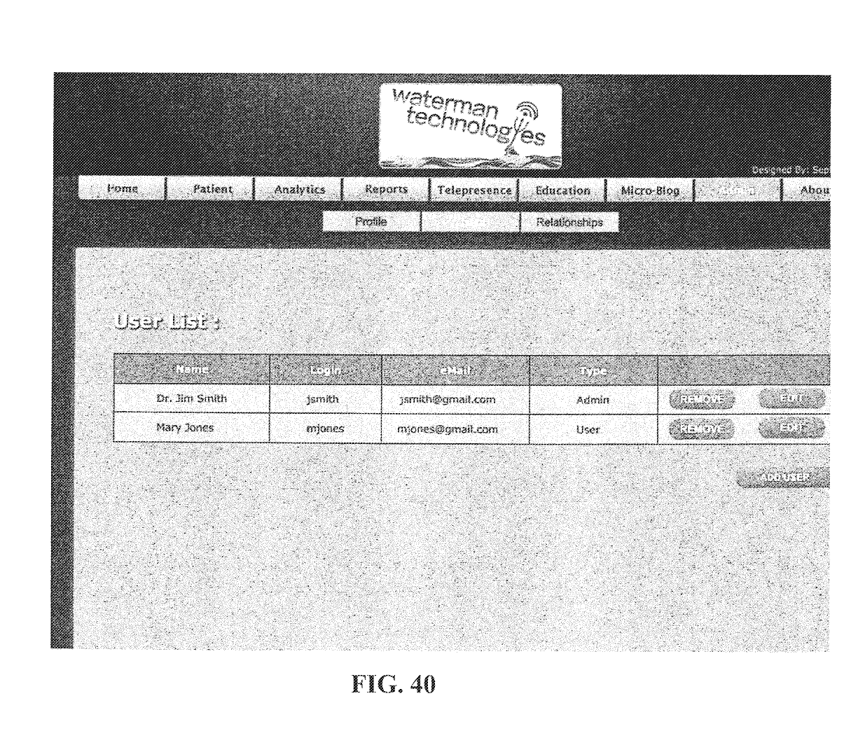

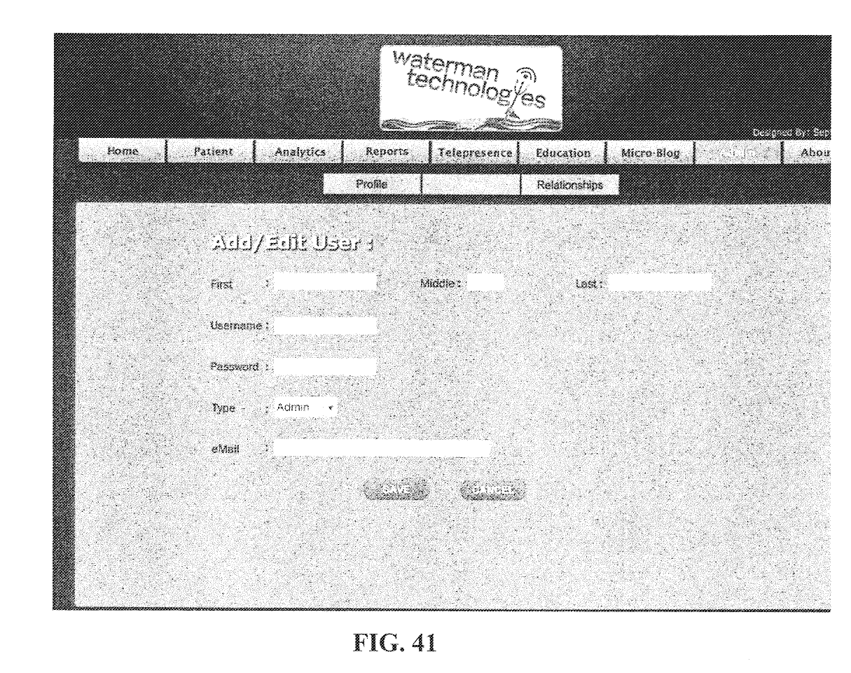

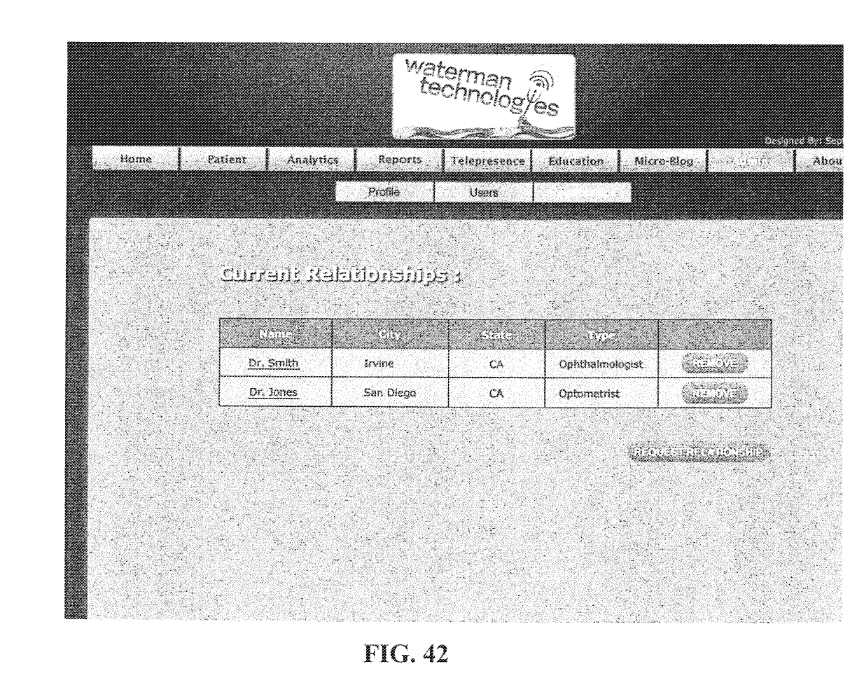

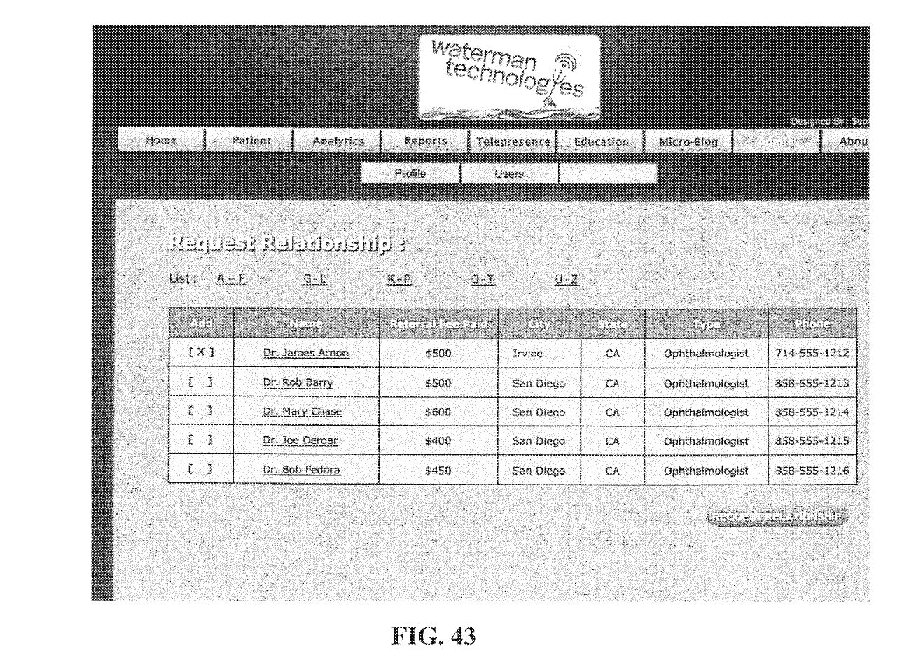

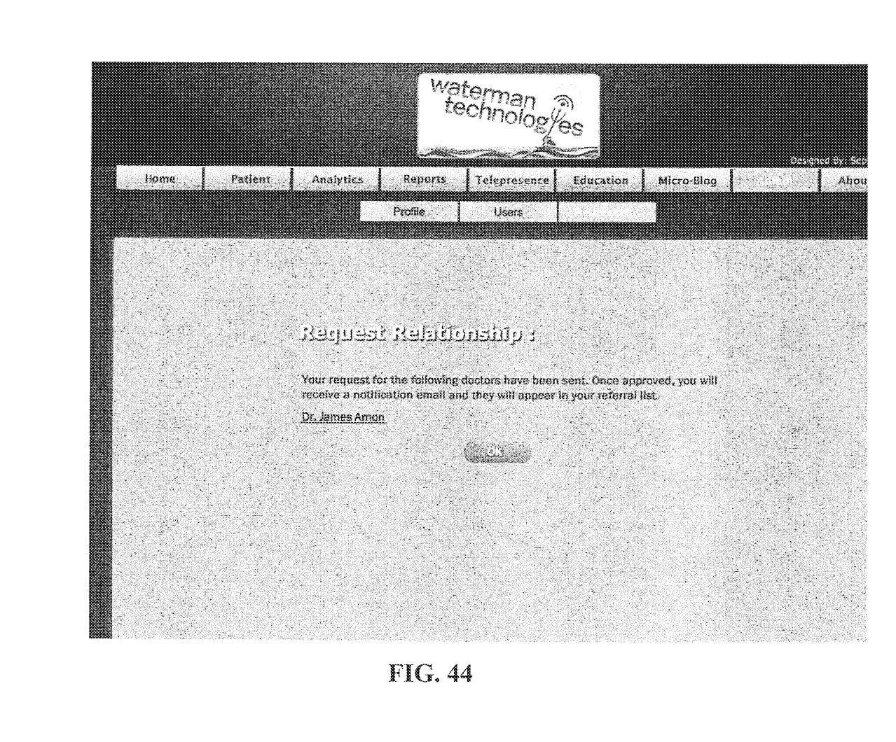

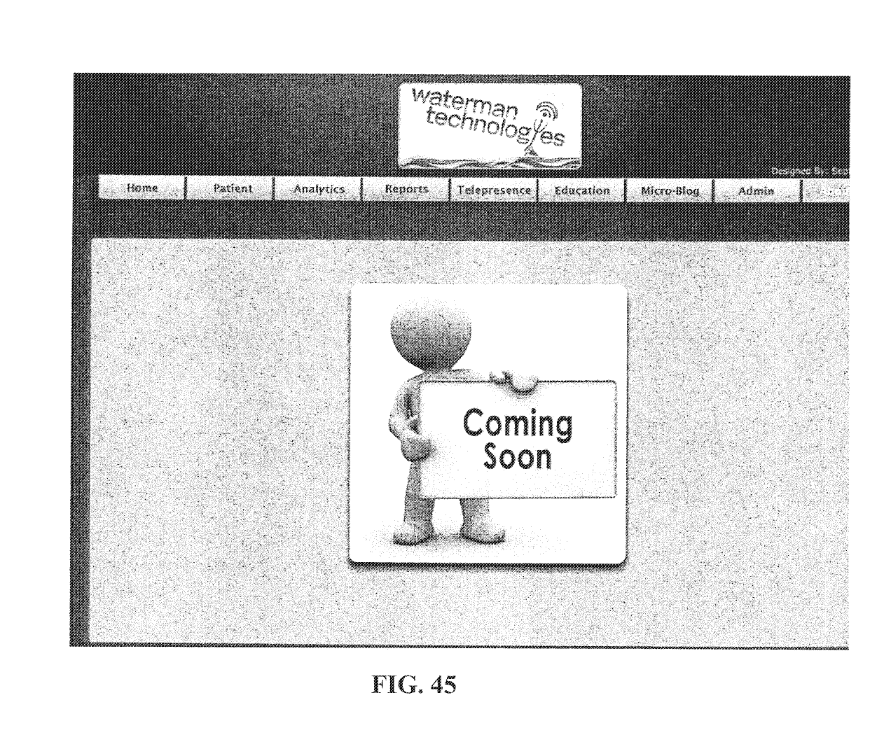

FIGS. 1-45 are screen shots of an exemplary embodiment of an electronic platform for co-management between an ophthalmology practice and an optometry practice. FIG. 1 is a screen shot of an exemplary menu screen of an exemplary embodiment of an electronic platform for co-management between an ophthalmology practice and an optometry practice. FIG. 2 is a screen shot of an exemplary “Add a new patient” screen 1 of an exemplary embodiment of the electronic platform. FIG. 3 is a screen shot of an exemplary “Add a new patient” screen 2 of an exemplary embodiment of the electronic platform. FIG. 4 is a screen shot of an exemplary “Add a new patient” screen 3 of an exemplary embodiment of the electronic platform. FIG. 5 is a screen shot of an exemplary “Add a new patient” screen 4 of an exemplary embodiment of the electronic platform. FIG. 6 is a screen shot of an exemplary “Find a Patient” and “Patient List” screen of an exemplary embodiment of the electronic platform. FIG. 7 is a screen shot of an exemplary “Patient Details” screen of an exemplary embodiment of the electronic platform. FIG. 8 is a screen shot of an exemplary “Patient Visits” screen of an exemplary embodiment of the electronic platform. FIG. 9 is a screen shot of an exemplary “Add Patient Visit” screen of an exemplary embodiment of the electronic platform. FIG. 10 is a screen shot of an exemplary “Patient Procedures” screen of an exemplary embodiment of the electronic platform. FIG. 11 is a screen shot of an exemplary “Add Procedure” screen of an exemplary embodiment of the electronic platform. FIG. 12 is a screen shot of an exemplary “Patient Referrals” screen of an exemplary embodiment of the electronic platform. FIG. 13 is a screen shot of an exemplary “Add Referral” screen of an exemplary embodiment of the electronic platform. FIG. 14 is a screen shot of an exemplary “Top Referrers” screen of an exemplary embodiment of the electronic platform. FIG. 15 is a screen shot of an exemplary “Revenue Per Product” screen of an exemplary embodiment of the electronic platform. FIG. 16 is a screen shot of an exemplary “Clinical Metrics” screen of an exemplary embodiment of the electronic platform. FIG. 17 is a screen shot of an exemplary “Additional Clinical Metrics” screen of an exemplary embodiment of the electronic platform. FIG. 18 is a screen shot of an exemplary “Referral List” screen of an exemplary embodiment of the electronic platform. FIG. 19 is a screen shot of an exemplary “Patient Revenue” screen of an exemplary embodiment of the electronic platform. FIG. 20 is a screen shot of an exemplary “Doctor Revenue” screen of an exemplary embodiment of the electronic platform. FIG. 21 is a screen shot of an exemplary “Fee Report” screen of an exemplary embodiment of the electronic platform. FIG. 22 is a screen shot of an exemplary “Automatic System Generated Monthly Ophthalmologist Invoice Email” screen of an exemplary embodiment of the electronic platform. FIG. 23 is a screen shot of an exemplary “Automatic System Generated Monthly Optometrist Credit Statement Email” screen of an exemplary embodiment of the electronic platform. FIG. 24 is a screen shot of an exemplary telepresence screen of an exemplary embodiment of the electronic platform. FIG. 25 is a screen shot of an exemplary embodiment of an educational page screen, depicting information on “Calhoun Light Adjustable Lens.” FIG. 26 is a screen shot of an exemplary embodiment of an educational page screen, depicting a second page of information on “Calhoun Light Adjustable Lens.” FIG. 27 is a screen shot of an exemplary embodiment of an educational page screen, depicting information on “Visiogen Synchrony.” FIG. 28 is a screen shot of an exemplary embodiment of an educational page screen, depicting a second page of information on “Visiogen Synchrony.” FIG. 29 is a screen shot of an exemplary embodiment of an educational page screen, depicting a third page of information on “Visiogen Synchrony.” FIG. 30 is a screen shot of an exemplary embodiment of an educational page screen, depicting information on “Alcon ReSTOR.” FIG. 31 is a screen shot of an exemplary embodiment of an educational page screen, depicting a second page of information on “Alcon ReSTOR.” FIG. 32 is a screen shot of an exemplary embodiment of an educational page screen, depicting information on “Tetraflex.” FIG. 33 is a screen shot of an exemplary embodiment of an educational page screen, depicting information on “NuLens.” FIG. 34 is a screen shot of an exemplary embodiment of an educational page screen, depicting information on “VisionCare I.M.T.” FIG. 35 is a screen shot of an exemplary embodiment of an educational page screen, depicting information on “Crystalens HD.” FIG. 36 is a screen shot of an exemplary embodiment of an educational page screen, depicting a second page of information on “Crystalens HD.” FIG. 37 is a screen shot of an exemplary embodiment of an educational page screen, depicting information on “Ziemer.” FIG. 38 is a screen shot of an exemplary micro-blog screen of an exemplary embodiment of the electronic platform. FIG. 39 is a screen shot of an exemplary “View Profile” screen of an exemplary embodiment of the electronic platform. FIG. 40 is a screen shot of an exemplary “User List” screen of an exemplary embodiment of the electronic platform. FIG. 41 is a screen shot of an exemplary “Add/Edit User” screen of an exemplary embodiment of the electronic platform. FIG. 42 is a screen shot of an exemplary “Current Relationships” screen of an exemplary embodiment of the electronic platform. FIG. 43 is a screen shot of an exemplary “Request Relationships” screen of an exemplary embodiment of the electronic platform. FIG. 44 is a screen shot of an exemplary “Request Relationships” screen 2 of an exemplary embodiment of the electronic platform. FIG. 45 is a screen shot of an exemplary “Coming Soon” screen of an exemplary embodiment of the electronic platform.

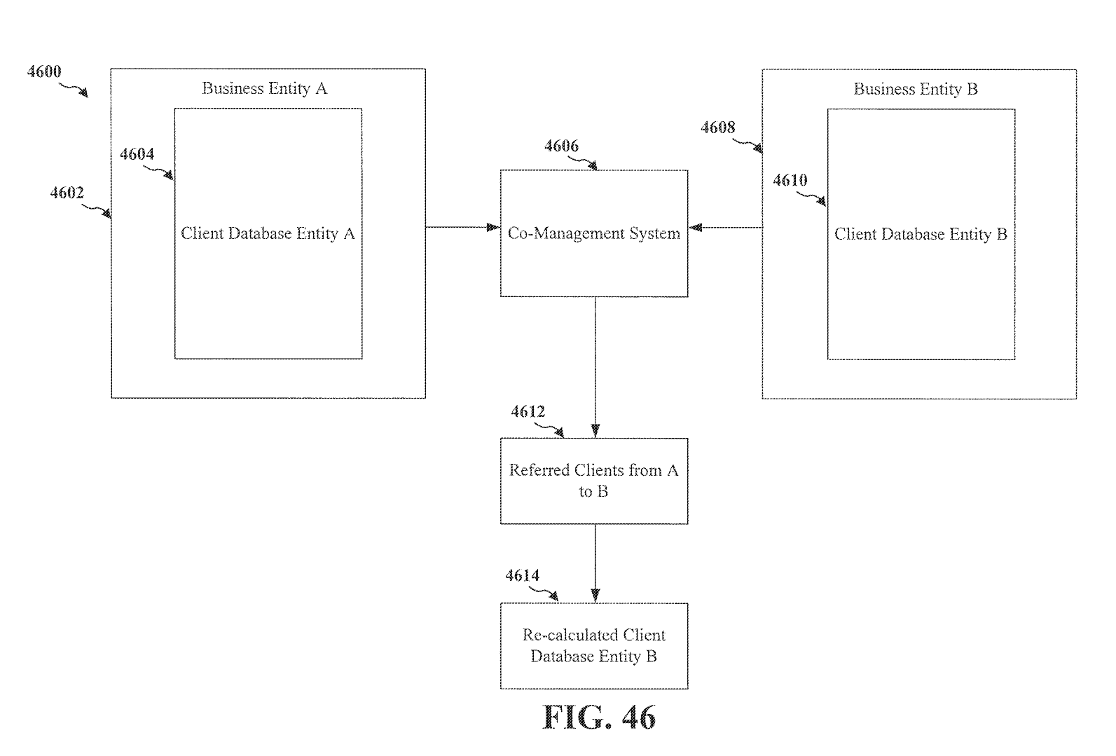

FIG. 46 is an illustration 4600 of two business entities comprising a shared co-management system. Business entity A 4602 may include any business with a database of clients, as illustrated by client database entity A 4604. Similarly, business entity B 4608 may also include any business with a database of clients, as illustrated by client database entity B 4610. According to one embodiment, business entity A 4602 refers one or more clients out from its respective client database entity A 4604 to business entity B 4608 to add to its respective client database entity B 4610. Both business entities are connected to a co-management system 4606. The co-management system 4606 may serve as an intermediary between the two business entities 4602 and 4608. The co-management system 4606 may either be a virtual, software based system embedded in computer hardware, or a physical entity or establishment. The co-management system 4606 is responsible for monitoring, managing and tracking the clients for both business entities 4602 and 4608, and the transfer of clients that are transferred out from business entity A 4602 to business entity B 4608 and vice-versa. The co-management system 4606 may track and manage the client databases 4602 and 4608 on a continuous basis, or during variable or fixed intervals of time. The clients that are referred out from business entity A 4602 to business entity B 4608 are shown by referred clients from A to B 4612. Finally, the re-calculated client database for entity B 4614 is the updated client database for business entity B 4608 that includes the clients that were referrals from business entity A 4602.

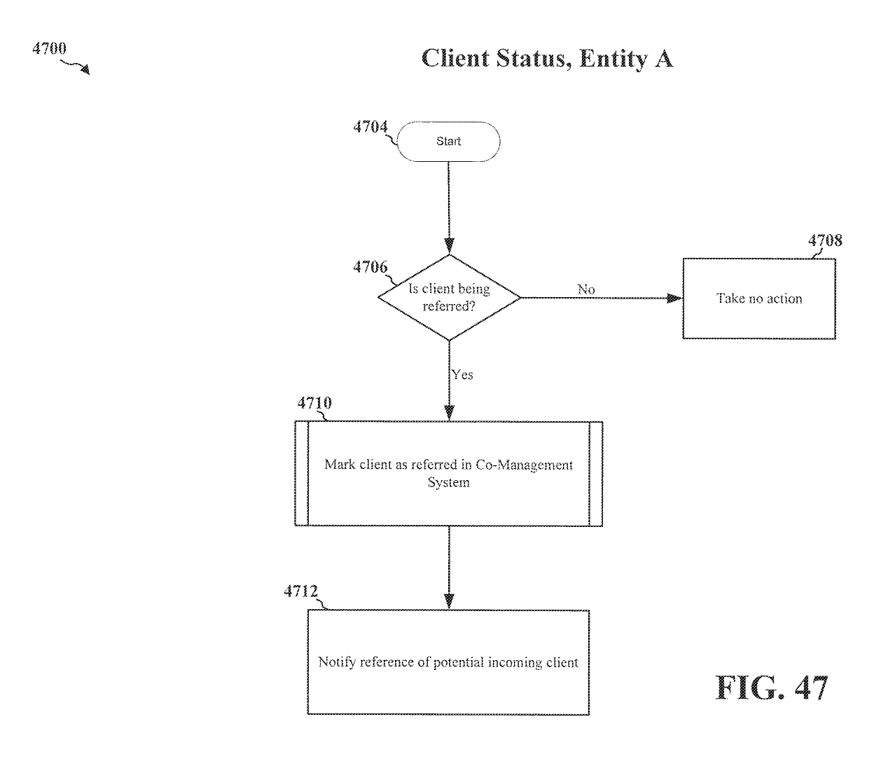

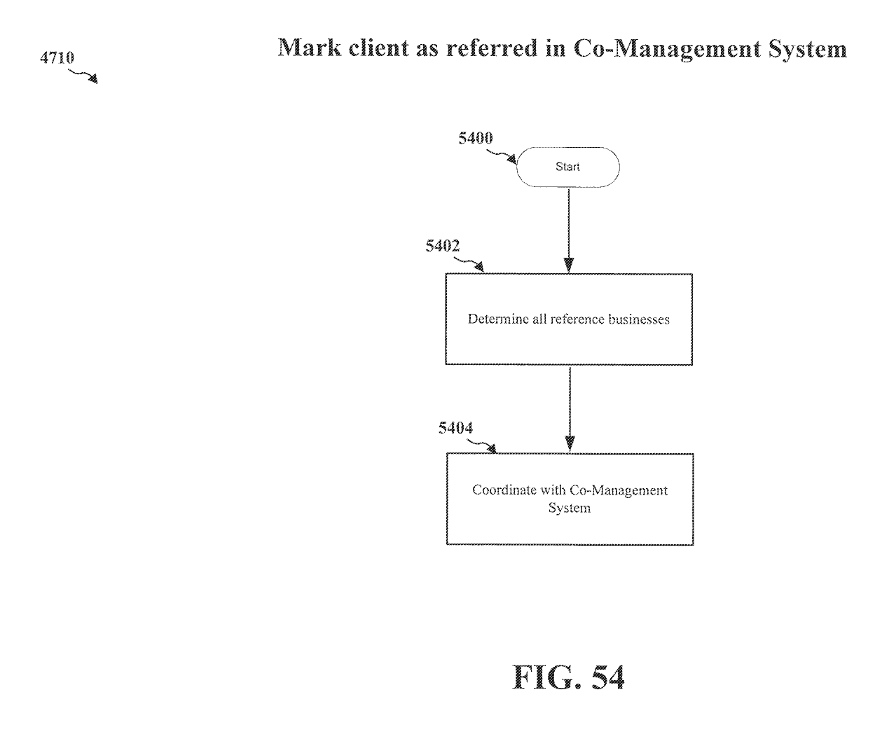

FIG. 47 is a flow chart showing an overview of a process 4700 for referring out a client from the perspective of business entity A 4602. The process begins at step 4704 wherein the co-management system 4606 described above tracks the flow of a client from business entity A 4602 to business entity B 4608. As described above, the co-management system 4606 may track the status of clients on a continuous basis. The process 4700 continues to decision step 4706 to determine whether or not a client is being referred out to business entity B as described above. If a client is not being referred out, then the process 4700 continues to step 4708 to take no action. Referring back to decision step 4706, if a client is being referred out to business entity B, the process 4700 continues to process step 4710 to mark the client as referred in the co-management system 4606. A marked client could be tagged, flagged, or have any other indication to show a client is being referred out to another business or multiple businesses. This process is shown in more detail with reference to FIG. 54 below. Finally, the process 4700 then continues to step 4712 to notify the reference, or business entity B, of the potential incoming client. The outgoing client may be referred out to multiple businesses, so there may be more than a single business entity B 4608.

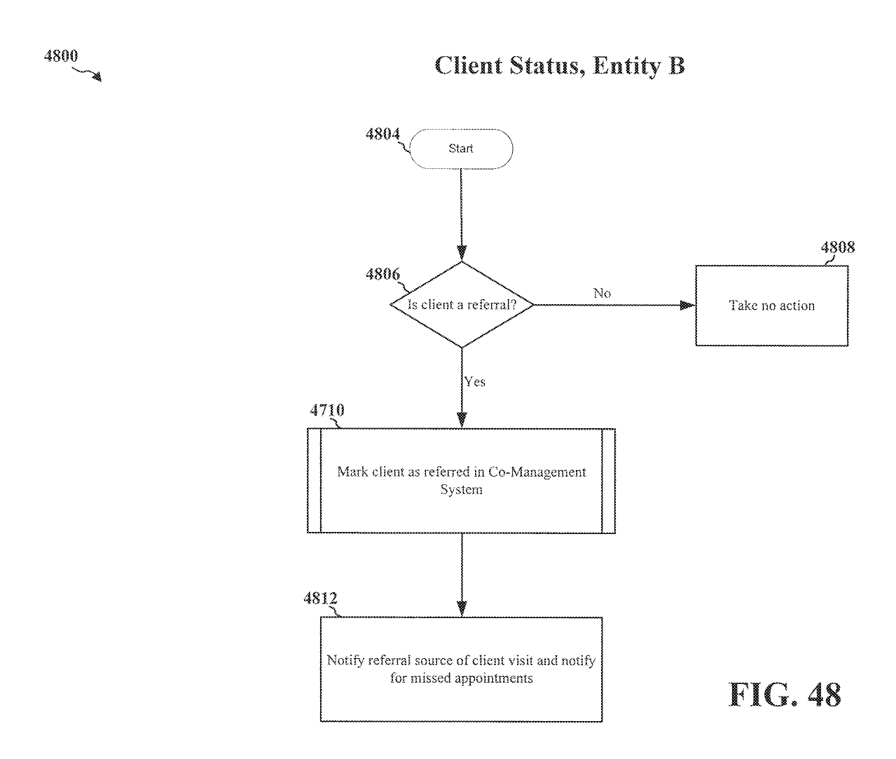

FIG. 48 is a flow chart showing an overview of a process 4800 for determining whether or not a client is a referral from business entity A 4602 from the perspective of business entity B 4608. The process begins at step 4804 wherein the co-management system 4606 described above tracks the flow of a client from business entity A 4602 to business entity B 4608. As described above, the co-management system 4606 may track the status of clients on a continuous basis. The process 4800 continues to decision step 4806 to determine whether or not a client is being referred in from business entity A as described above. An example is illustrated in FIG. 12 as a screen shot of “Patient Referrals” for a medical practice co-management scenario. If a client is not being referred in, the process 4800 continues to step 4808 to take no action. Referring back to decision step 4806, if a client is being referred in from business entity A, the process 4800 continues to process step 4710 to mark the client as referred in the co-management system 4606. A marked client could be tagged, flagged, or have any other indication to show a client is being referred in from another business or referred in from multiple businesses. This process is shown in more detail with reference to FIG. 54 below. Finally, the process 4800 then continues to step 4812 to notify the referral source, or business entity A, of the potential new client or for every visit of a repeat client. Furthermore, since the co-management system 4606 tracks the status of clients on a continuous basis, the referral source or business entity A 4602 is contacted regarding any missed appointments by the referred client.

Referring briefly to FIG. 12, the co-management database includes entries for the referred from doctor and the referred to doctor, so that the system can identify such patients as well as identify those entities who refer the most patients (e.g. FIG. 14) and those entities to whom the most patients are referred. It should be noted that a single patient may be the subject of multiple referrals, depending on the type of procedures associated with the patient. The system can capture such multiple referral links and track accordingly.

FIG. 54 begins at step 5400 once a determination has been made that a client is a referral. A client may be referred out to multiple businesses, or referred in from multiple businesses. The process 4710 then moves to step 5402 to determine all reference business relationships, outgoing and incoming. Finally, the process 4710 continues to step 5404 to coordinate all the outgoing and incoming references with the co-management system to ensure all the referred clients are tracked with respect to each incoming and outgoing business.

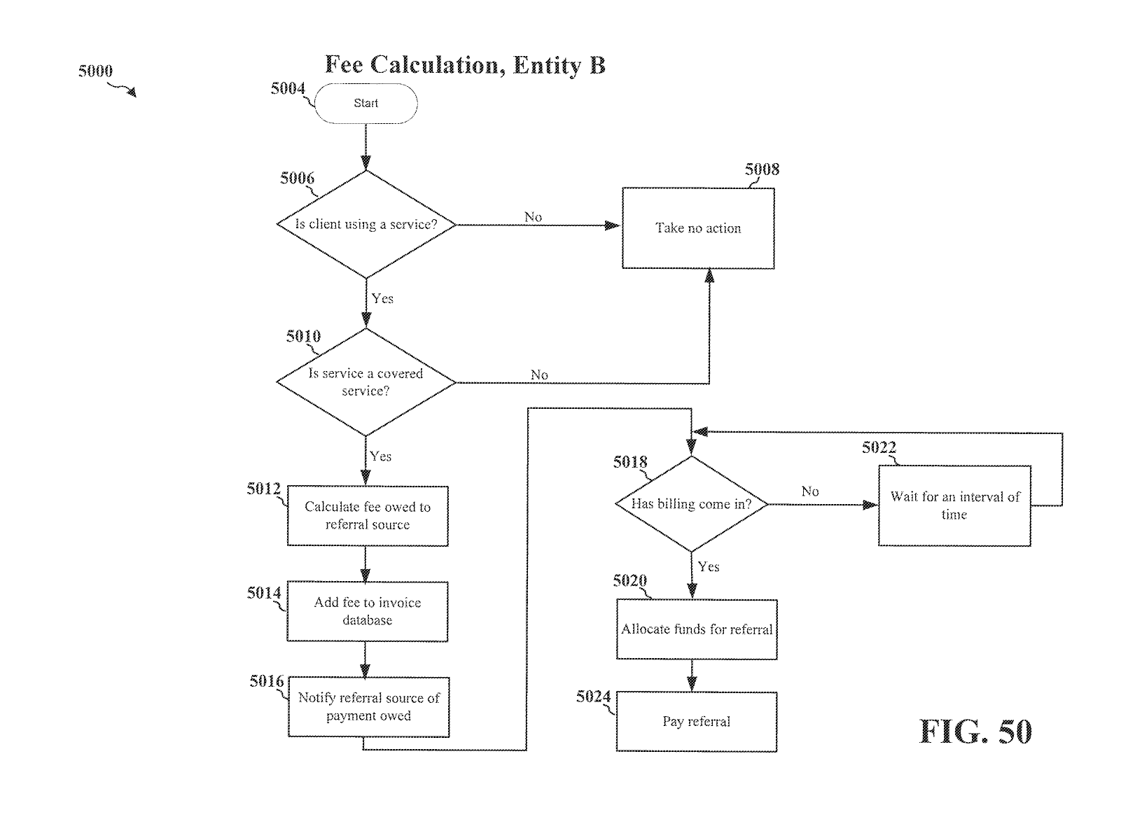

FIG. 50 is a flow chart showing an overview of a process 5000 for calculating a referral fee from the perspective of business entity B. The process 5000 begins at step 5004 after a client has already been referred out from business entity A 4602 to business entity B 4608 described above. The process 5000 continues to decision step 5006 to determine whether or not the referred out client from business entity A 4602 will be using a service from business entity B 4608. If the client does not use a service from business entity B 4608, then the process 5000 moves to step 5008 to take no action. In other words, business entity A 4602 will not receive a referral fee if the referred client does not end up using a service from business entity B 4608. Referring back to the decision step 5006, if the referred client from business entity A 4602 is using a service from business entity B 4608, the process 5000 moves to decision step 5010 to determine whether or not the service is a covered service. A covered service may include a service that involves a referral fee owed to business entity A 4602 from business entity B 4608 due to an agreement between the two business for a subset or services offered by business entity B 4608. An agreement between the two businesses may include a click-wrap agreement wherein, before a business entity B 4608 joins a referral network, he or she must agree to certain terms, including the automated direction of referral fees to the referring business entity A 4602, and an agreement to direct the referral back to the referring business entity A 4602 when it is not necessarily in the referral's best interest to return to business entity B 4608 for follow-up services. If the referred client is not using a covered service, the process 5000 moves to step 5008 to take no action. In other words, the referred client from business entity A 4602 is not using a service for which a referral fee is owed from business entity B 4608 to business entity A 4602 based on a previously arranged agreement between the two businesses. Referring back to decision step 5010, if the referred client is using a covered service, the process 5000 moves to step 5012 to calculate a fee owed to business entity A 4602. The calculated fee may vary based upon the number of total references made between the two businesses, the type of service being used, or due to variations in agreements between different types of businesses. Next, the process 5000 continues to step 5014 to add a fee to the invoice database. The fee may be stored in the co-management system 4606 described above to keep a record of the total fees owed to business entity A 4602. An example of this is shown in the sample screenshot of FIG. 21 as “Fee Reports” for a healthcare co-management platform, for referral fees owed to various referrers. The process 5000 continues to step 5016 to notify the referral source, or business entity A 4602 of the payment owed for a referral. Next, the process 5000 continues to decision step 5018 to determine whether or not billing has come in from the client for the service performed. For example, if business entity B 4608 accepts insurance as payment, has the insurance company paid business entity B 4608 for the service performed. If not, the process 5000 moves to step 5022 to wait for a duration of time before moving back to decision step 5018 to re-check if the payment has been received. If billing has been received, the process 5000 moves to step 5020 to allocate the requisite fees to the referral source for the referred client. Finally, the process moves to step 5024 to sent payment to the referral source, or business entity A 4602.

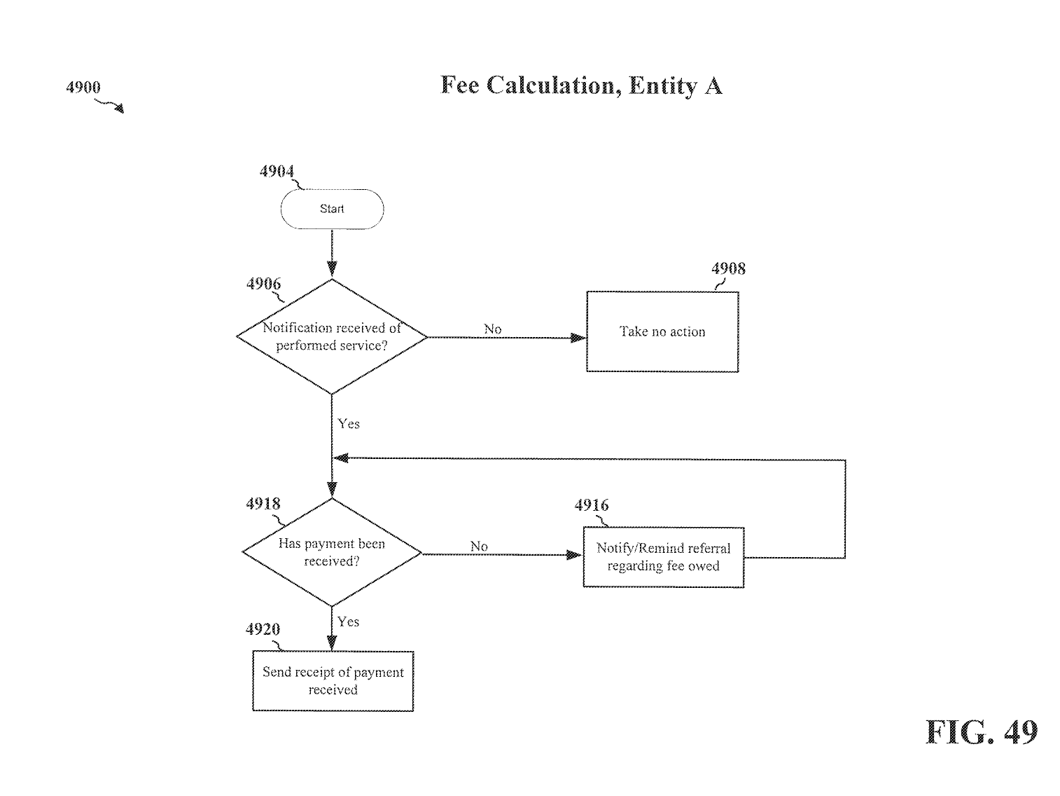

FIG. 49 is a flow chart showing an overview of a process 4900 for calculating a referral fee from the perspective of business entity A. The entire process 4900 may be managed by the co-management system 4606 described above. The process 4900 begins at step 4904 after a client has already been referred out from business entity A 4602 to business entity B 4608 described above. The process 4900 continues to decision block 4906 where it is determined if Entity A 4602 has received a notification from Entity B 4608 that a covered service has been performed (i.e. step 5016 of FIG. 50). If not, then the system takes no action at step 4908. If so, then the system proceeds to step 4918. The process then moves to decision block 4918 to determine whether or not payment has been received from business entity B 4608. If a payment has not yet been received, the process 4900 loops back to step 4916 to remind the referral of the reference fee owed. The reminder may notify the referral that a notification has been received that a service has been performed and a referral fee is owed. This may be done by the co-management system on variable intervals of time to follow up on the payment owed to business entity A 4602. Referring back to decision step 4918, if a payment has been received, the process 4900 continues to step 4920 to send receipt to business entity B 4608 of the payment received.

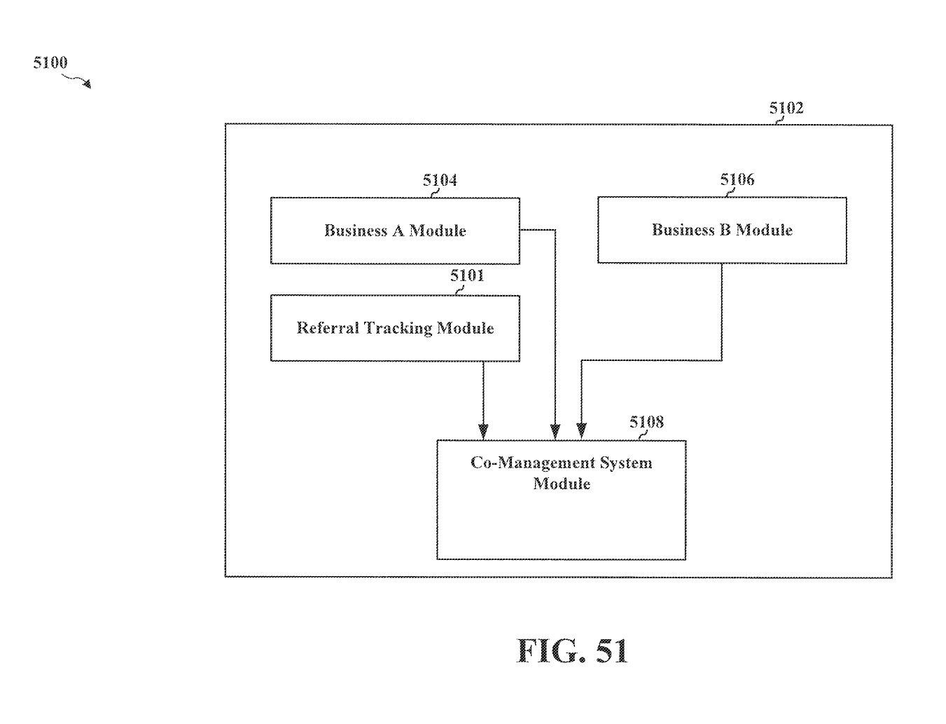

FIG. 51 is a block diagram 5100 illustrating the modules/means/components of business co-management system 5102. The apparatus includes a Business A Module 5104 that may be either a physical business or a virtual or software-based system for a business comprising a client database. The apparatus includes a Business B Module 5106 that may be either a physical business or a virtual or software-based system for a business comprising a client database. The Referral Tracking Module 5101 may track and manage the flow of clients from one business to another business. All modules 5101, 5104 and 5106 are connected to a Co-Management System Module 5108 that serves as an intermediary between the two businesses as discussed above with reference to FIG. 46. The Co-Management System Module 5108 may either be a virtual, software based system embedded in computer hardware, or a physical entity or establishment.

The apparatus may include additional modules that perform each of the steps of the algorithm in the aforementioned flow charts of FIGS. 47-50. As such, each step in the aforementioned flow charts of FIGS. 47-50 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

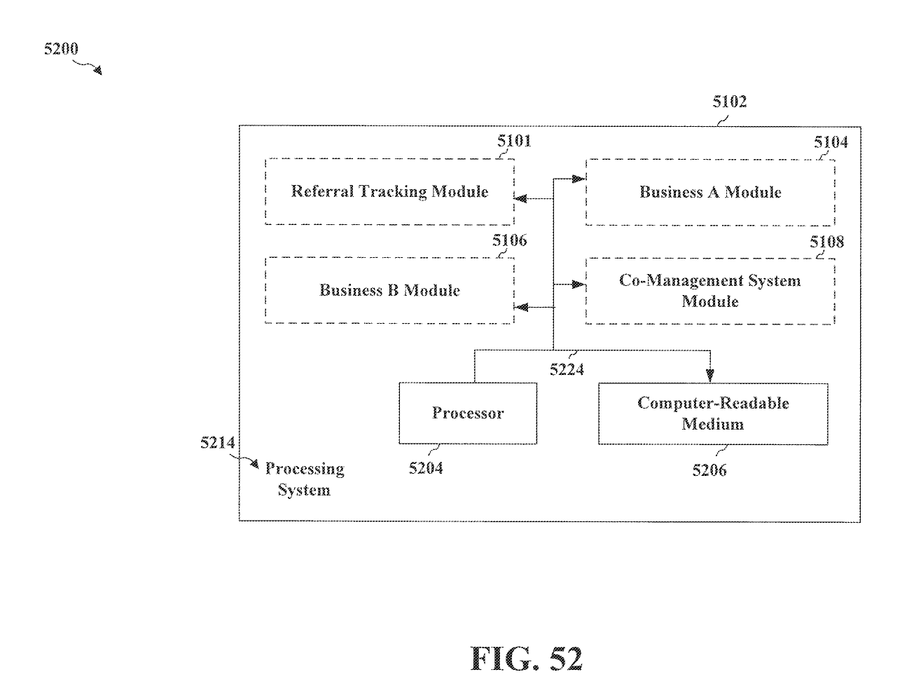

FIG. 52 is a diagram 5200 illustrating an example of a hardware implementation for a business co-management system 5102 employing a processing system 5214. The processing system 5214 may be implemented with a bus architecture, represented generally by the bus 5224. The bus 5224 may include any number of interconnecting buses and bridges depending on the specific application of the processing system 5214 and the overall design constraints. The bus 5224 links together various circuits including one or more processors and/or hardware modules, represented by the processor 5204, the modules 5101, 5104, 5106 and 5108 and the computer-readable medium 5206. The bus 5224 may also link various other circuits such as timing sources, peripherals, voltage regulators, and power management circuits, which are well known in the art, and therefore, will not be described any further.

The processing system 5214 includes a processor 5204 coupled to a computer-readable medium 5206. The processor 5204 is responsible for general processing, including the execution of software stored on the computer-readable medium 5206. The software, when executed by the processor 5204, causes the processing system 5214 to perform the various functions described supra for any particular apparatus. The computer-readable medium 5206 may also be used for storing data that is manipulated by the processor 5204 when executing software. The processing system further includes at least one of the modules 5101, 5104, 5106 and 5108. The modules may be software modules running in the processor 5204, resident/stored in the computer readable medium 5206, one or more hardware modules coupled to the processor 5204, or some combination thereof.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

In one or more aspects of the disclosure, the functions described may be implemented in hardware, software, firmware, or any combination thereof. If implemented in software, the functions may be stored on or transmitted over as one or more instructions or code on a computer-readable medium. Computer-readable media may be transitory or non-transitory, and may include both computer storage media and communication media including any medium that facilitates transfer of a computer program from one place to another. Storage media may be any available media that can be accessed by a general purpose or special purpose computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are transitory entities included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Computer-readable media may be embodied in a computer-program product. By way of example, but without limitation, a computer-program product may include a computer-readable medium in packaging materials. Those skilled in the art will recognize how best to implement the described functionality presented throughout this disclosure depending on the particular application and the overall design constraints imposed on the overall system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. A method, as performed by a processor embedded in computer hardware, for co-management between a first business entity and a second business entity comprising, wherein the method comprises:
retrieving an electronic record for a client;
storing first electronic record for the client corresponding to a recommended service of the client by the first business entity;
referring the client to the second business entity in response to the recommended service of the client, corresponding to service provided by the second business entity;
providing the electronic record to the second business entity;
storing second electronic record for the client corresponding to service of the client by the second business entity;
scheduling at least one follow-up visit for the client at one of the first business entity or the second business entity; and
distributing a first portion of a referral fee from the second business entity to the first business entity, and a second portion of the referral fee to a co-management system provider.

2. The method of claim 1, wherein the method further comprises tracking and trending the data corresponding to the first business entity and the second business entity.

3. The method of claim 1, wherein a reminder is sent from the first business entity to the second business entity when the first portion of the referral fee is not received by the first business entity.

4. The method of claim 1, wherein the second business entity distributes the first portion of the referral fee after the second business entity receives payment from the client.

5. The method of claim 4, wherein the client sends payment through an insurance provider.

6. The method of claim 1, wherein the first portion of a referral fee is distributed from the second business entity to the first business entity if a service is performed for the client by the second business entity.

7. The method of claim 1, wherein the first business entity is notified regarding every appointment with the second business entity.

8. The method of claim 1, wherein the first business entity is notified regarding a missed appointment with the second business entity.

9. The method of claim 1, wherein the first business entity comprises multiple businesses.

10. The method of claim 1, wherein the second business entity comprises multiple businesses.

11. A system for co-management between a first business entity and a second business entity, wherein the system comprises:
a first business module corresponding to the first business entity for storing a first client database;
a second business module corresponding to the second business entity for storing a second client database;
a co-management system module for
retrieving an electronic record for a client;
storing the first electronic record for the client corresponding to a recommended service of the client by the first business entity;
providing the electronic record to the second business entity;
storing second electronic record for the client corresponding to service of the client by the second business entity;
scheduling at least one follow-up visit for the client at one of the first business entity or the second business entity;
distributing a first portion of a referral fee from the second business entity to the first business entity, and a second portion of the referral fee to a co-management system provider; and
a referral tracking module for referring the client to the second business entity in response to the recommended service of the client, corresponding to service provided by the second business entity.

12. The system of claim 11, further comprising a pattern recognition module for tracking and trending the data corresponding to the first business module, the second business module, and the co-management module.

13. The system of claim 11, wherein the first business module sends a reminder to the second business module when the first portion of the referral fee is not received by the first business entity.

14. The system of claim 11, wherein the second business entity distributes the first portion of the referral fee after the second business entity receives payment from the client

15. The system of claim 14, wherein the client sends payment through an insurance provider.

16. The system of claim 11, wherein the first portion of a referral fee is distributed from the second business entity to the first business entity if a service is performed for the client by the second business entity.

17. The system of claim 11, wherein the first business entity is notified regarding every appointment with the second business entity.

18. The system of claim 11, wherein the first business entity is notified regarding a missed appointment with the second business entity.

19. The system of claim 11, wherein the first business entity comprises multiple businesses.

20. The system of claim 11, wherein the second business entity comprises multiple businesses.

21. A non-transitory, computer readable media, comprising instructions that when executed by a processor, cause the processor to perform a method for co-management between a first business entity and a second business entity comprising, wherein the method comprises:
retrieving an electronic record for a client;
storing first electronic record for the client corresponding to a recommended service of the client by the first business entity;
referring the client to the second business entity in response to the recommended service of the client, corresponding to service provided by the second business entity;
providing the electronic record to the second business entity;
storing second electronic record for the client corresponding to service of the client by the second business entity;
scheduling at least one follow-up visit for the client at one of the first business entity or the second business entity; and
distributing a first portion of a referral fee from the second business entity to the first business entity, and a second portion of the referral fee to a co-management system provider.

22. The method of claim 21, wherein the method further comprises tracking and trending the data corresponding to the first business entity and the second business entity.

23. The method of claim 20, wherein a reminder is sent from the first business entity to the second business entity when the first portion of the referral fee is not received by the first business entity.

24. The method of claim 20, wherein the second business entity distributes the first portion of the referral fee after the second business entity receives payment from the client.

25. The method of claim 24, wherein the client sends payment through an insurance provider.

26. The method of claim 20, wherein the first portion of a referral fee is distributed from the second business entity to the first business entity if a service is performed for the client by the second business entity.

27. The method of claim 20, wherein the first business entity is notified regarding every appointment with the second business entity.

28. The method of claim 20, wherein the first business entity is notified regarding a missed appointment with the second business entity.

29. The method of claim 20, wherein the first business entity comprises multiple businesses.

30. The method of claim 20, wherein the second business entity comprises multiple businesses.
